(19) United States
(12) Patent Application Publication
(10) Pub. No.: US 2006/0026079 A1
(43) Pub. Date: Feb. 2, 2006

(54) Method and system for scheduling auditions

(75) Inventor: Susan Jean Fox, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Casting Workbook Services Inc., Vancouver (CA)

(21) Appl. No.: 11/102,730

(22) Filed: Apr. 11, 2005

Related U.S. Application Data
(60) Provisional application No. 60/560,594, filed on Apr. 9, 2004.
(60) Provisional application No. 60/560,596, filed on Apr. 9, 2004.

(51) Int. Cl. G06Q 30/00

(52) U.S. Cl. 705/26; 705/1

(57) ABSTRACT

The traditional method for casting directors to schedule talent auditions with talent such as actors and their agents is laborious and time consuming. The invention provides a method of using the Internet to facilitate an improved interactive scheduling method.

### REFERENCE TO RELATED APPLICATION

This application claims priority from U.S. provisional application Nos. 60/560,594 and 60/560,596 both filed Apr. 9, 2004, which are pending.

### TECHNICAL FIELD

The invention relates to the entertainment industry, particularly film and television and more particularly to the casting and auditioning of talent such as actors.

### BACKGROUND

In the entertainment industry, particularly film and television, traditionally Casting Directors or Producers (“Buyers”) send out announcements about an open role they wish to cast. These announcements are called Casting Notices, Breakdowns or Briefs. Agents (“Sellers”) answer these calls by submitting information about their Actors, or in some cases, unrepresented Actors submit information about themselves. In addition, studio casting executives gather actor names for audition sessions from lists or other internal sources before or after a Breakdown has been sent. After gathering the submissions, Buyers can go through the submissions and sort them into different lists. For example, there may be an A list, B list, and a C list. The A list has actors that the Buyer would like to audition; the B list would be their second choice; and C List their third. After sorting through the submissions, the Buyers then start to organize audition times for the actors. In the following description, “Buyers” refers to Casting Directors, Producers, Studios and the like, “Sellers” refers to Agents and Managers, and “Talent” refers to Actors, Models, Writers, Directors, etc. Talent can be represented by a Seller or can be unrepresented where they have limited but direct access to Buyers.

The process of organizing the schedule for auditions is time-consuming and arduous. It involves making lists of different audition times for each actor, making phone calls and sending emails to the Sellers. To create the times, the Buyers will count the number of actors they wish to audition, determine how many hours they have available for audition, and then start scheduling proposed times for each actor. After the proposed times have been created, the Buyers then look up the Seller's contact information, call them to discuss the audition time, make notes on who was contacted and whether the time was confirmed, regretted or tentative. Tentative answers generally require further phone calls, and in the case of regrets, the Buyer must find Actors to fill regretted spots in the audition schedule. Sometimes, the Buyer must wait for the Seller to return their phone call. If the time cannot be confirmed, the Buyer and Seller must negotiate a new time, which requires the Buyer to contact the Seller to change times, repeating the entire process.

In addition to creating audition times, the Buyer provides information about the audition location, the project, the script or script pages. The script or script pages are usually sent by fax to each Seller. If the Seller is an Agent, the Agent will then re-transmit the script or script pages to the Actor. This transfer of information must be done in a short time frame so that the Actor has time to prepare for the audition: The traditional method of scheduling auditions is thus laborious and time consuming for all parties involved, especially for the Buyers and their assistants. There is no universal standard of communication between parties, and each party expends time tracking requests and information. Computers with internet connections are now commonplace in the offices of Buyers and Sellers. Furthermore, Actors have computers with internet access at home or access to public computers, so Buyers and Sellers have the necessary tools to access the internet and utilize an online audition scheduling system that would save time and money as well as reduce errors and omissions.

Traditionally, Buyers pay for the use of a Casting Facility to hold auditions, create tapes or clips of the auditions, and then transfer those auditions to VHS tapes or DVDs so that they can be couriered globally to recipients. It is becoming more common that Buyers and Casting Facilities tape auditions using a digital camera that is connected to a computer. Using commercially available editing software, they can create DVD's, or VHS tapes, of the auditions for the project executives. However, existing methods of delivering these videos are not secure and the videos and other information about the project and actors considered for the role are subject to theft. After the Actor is cast, the Seller can begin to market the Actor in the role. Generally the Seller or Actor contacts other Buyers by sending notices of the upcoming performance. The preparation and dissemination of these notices by mail or courier is another cost to the Seller or Actor in time and money. Furthermore, there is no guarantee that the intended recipient will receive these notices, and it is not practical for the sender to forward the notice to everyone who might be able to further the career of the Actor. Therefore Actors and Agents restrict distribution to those most likely to see the performance.

Sellers also receive announcements from Actors who want to be represented. Traditionally, Buyers ask for complimentary tickets from the Seller to be left at the door of the venue or at the Will Call. To do this, Buyers must call the Seller or send an email. The Seller will then leave the tickets at the door. Buyers are constantly reviewing various appearances in order to stay current and locate new and upcoming talent for their projects. The ability to search for performances in all media in one central location does not currently exist. Further, Projects and Productions look for ways to market and sell tickets. In some cases, they are looking for distributors, production financing, or project showings for ongoing promotion of the production company itself. Venues also look for new ways to market their events and post online event calendars for their future productions.

### SUMMARY OF INVENTION

The invention provides a method of using the internet to permit a Buyer to schedule and manage auditions of Talent for a project with Sellers representing said Talent, said Buyer having a computer with a web browser and said Sellers each having a computer with electronic mail capability, the method comprising: i) providing a web site accessible over the Internet to said Buyer and communicating with a database; ii) said Buyer accessing said web site and selecting a project for audition scheduling; iii) said Buyer building a preliminary schedule by a) setting the audition start time and date, the number of Talent to be auditioned, and the length of time for each audition; b) selecting and ranking Talent for a particular role; and c) assigning a time for each Talent audition; iv) said Buyer sending said preliminary schedule to Sellers representing said Talent by electronic mail as an audition request; and v) said Buyer updating said schedule according to the responses received from said Sellers. According to one aspect, the times for each Talent are automatically assigned to Talent based on the ranking. Further according to one aspect, the audition times are re-assigned after the preliminary schedule request has been sent and any affected Seller is notified electronically of the change.

### BRIEF DESCRIPTION OF DRAWINGS

In drawings which disclose a preferred embodiment of the invention:

FIG. 1A is a Flow Chart illustrating the different parts of the invention;

FIG. 1B is a Flow Chart illustrating the interaction between Scheduling module of the invention for Buyers;

FIG. 2 is a Flow Chart illustrating the Build module of the invention for Buyers;

FIG. 3 is a Flow Chart illustrating the Send module of the invention for Buyers;

FIG. 4 is a Flow Chart illustrating the Manage module of the invention for Buyers;

FIG. 5 is a Flow Chart illustrating the Report module of the invention for Buyers;

FIG. 6 is a Flow Chart illustrating the Upload Session module of the invention for Buyers;

FIG. 7 is a Flow Chart illustrating integration of the Scheduling Invention with the Seller login to Casting Workbook website;

FIG. 8 is a Flow Chart illustrating Large Grid of current Scheduling Audition Requests for Sellers;

FIG. 9 is a Flow Chart illustrating Grid of current Scheduling Audition Requests for a single Talent for Sellers;

FIG. 10 is a Flow Chart illustrating Review of Scheduling worksheets for a single Project for Sellers;

FIG. 11 is a Flow Chart illustrating Talent Calls management in Scheduling system for Sellers;

FIG. 12 is a Flow Chart illustrating Scheduling single Project Grid of current Audition Requests for Sellers;

FIG. 13 is a Flow Chart illustrating Send Materials management in Scheduling system for Sellers;

FIG. 14 is a Flow Chart illustrating Reports management in Scheduling system for Sellers;

FIG. 15 is a Flow Chart illustrating Take Action method in Scheduling system for Sellers;

FIG. 16 is a block diagram illustrating Notes History method in Scheduling system for Sellers;

FIG. 17 is a flow chart illustrating Talent Contact Info method in Scheduling system for Sellers;

FIG. 18 is a Flow Chart illustrating Add Talent to Sellers Scheduling system;

FIG. 19 is a Flow Chart illustrating Talent Cover Pages integration to Sellers Scheduling system;

FIG. 20 is a block diagram illustrating a computer network for carrying out the marketing module of the invention (“Now Appearing”));

FIG. 21 is a flow chart illustrating the flow of the marketing module of the invention; and

FIG. 22-33 are copies of web pages displayed during the operation of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

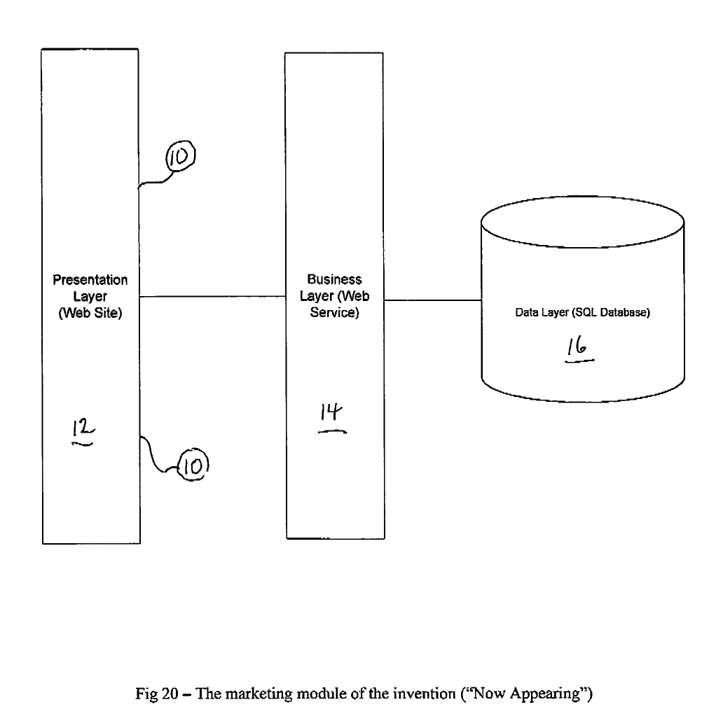

The invention provides a method of utilizing the Internet to create, manage and report audition schedules; store and distribute supporting documents for the audition; upload the session clips to a secure web service; provide the means to distribute videos securely; and provide the means for the Buyers and Sellers to market the project and actors. The invention integrates with an existing system for creating and managing projects for Buyers. The project types can be of any performance type. Examples of performance types are: Film and Television, Commercial; Theatrical; and Modelling. The industry term for these projects in North America is “Breakdowns”. In Australia it is “Briefs”. The invention preferably is structured as a three-tiered web application as shown in FIG. 20, with a graphical interface for the presentation layer 12, where Buyers, Sellers and Talent access the information and communicate with each other. Web Services and .Net components encapsulate the business layer 14 and an SQL Database 16 forms the data layer. In recent years a set of specifications has been standardized for a model of distributed computing architecture called XML Web Services. A Web Service is a software system designed to support interoperable machine-to-machine interaction over a network. It has an interface described in a machine-processable format (specifically WSDL). Other systems interact with the Web service in a manner prescribed by its description using SOAP-messages, typically conveyed using HTTP with an XML serialization in conjunction with other Web-related standards. XML Web Services standards provide a high level of interoperability across platforms, programming languages and applications. Web Services are a loosely-coupled, language-neutral, platform-independent way of linking applications across the Internet. Email transmission functionality may be provided using a proprietary method promoted under the trademark ePitch, which is the subject of co-pending U.S. provisional patent application Ser. No. 60/560,595 filed Apr. 9, 2004, and a corresponding regular United States patent application filed Apr. 8, 2005, both of which are entitled Method and System for Internet Delivery of Customized Information Packages and which are pending and are incorporated herein by reference.

As shown in FIG. 20, a number of users (Buyers, Sellers, Talent) 10 have access to the Internet using Internet browser software. The present invention uses a three-layer system, the Presentation Layer, Business Layer and Database Layer, wherein the Business Layer is maintained in a secure Web Service 14. Users 10 have access to the Portal Web Site 12 by entering the URL into the address bar of their web browser. Portal Web Site 12 functions as the Presentation Layer, and provides the graphical interface for users 10 to access the modules described below. A Web Service 14 is used to communicate to a secure Database 16 and to perform the Business Layer functions. For example, a web site at www.castingworkbook.com, would act as a portal web server which will serve as the Presentation Layer of the invention. The User 10 will not be aware of any differences in functionality between the Web Service 14 and Presentation 12 layers due to seamless integration.

The following are the central functions of the casting system:
1. Storage and management of a) Rosters (groups of Talent represented by Sellers); and b) Castlists (groups of Talent stored by Buyers, in this case, Studio buyers);
2. Searches by Buyers of all public data as well as their internal Castlists and Sellers of their internal Rosters as well as Unrepresented Talent;
3. Distribution of Buyer, Seller or Talent materials via electronic or physical means;
4. Promotion of Talent by Buyer, Seller or Talent;
5. Bookings of Talent by Buyers through i) Breakdowns (job notices sent by Buyers to Sellers), ii) Casting Notices (job notices sent by Buyers to Sellers and Talent), iii) Breakdown Submissions (Talent portfolios sent by Sellers to Buyers), iv) Sides & Scripts (posted by Buyers for distribution to Sellers and Talent for Auditions), and v) Scheduling (booking workflow for communication between Buyers, Sellers, Talent & Casting Facilities (where auditions are taped) for managing the Audition Session (the taping of multiple auditions).
6. Uploading of audio and video auditions by Buyers, Sellers and Talent.
7. Communication between all Buyer, Seller and Talent members based upon permissions and type.

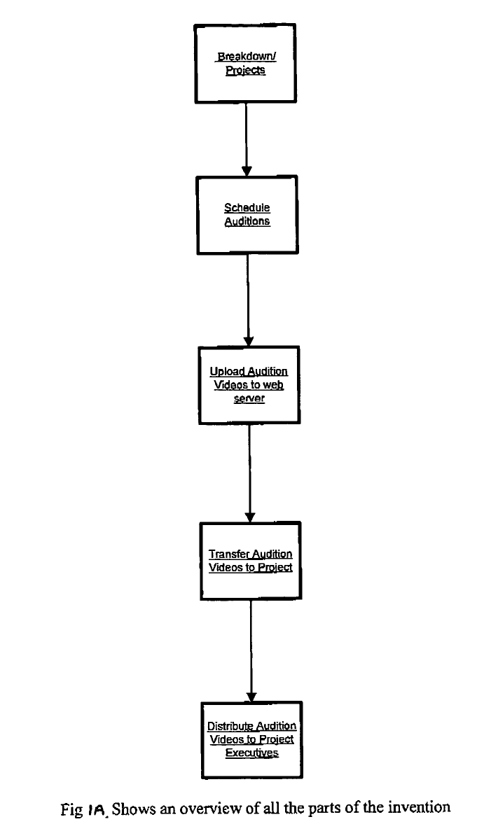

FIG. 1A illustrates an overview of the process. A Buyer posts a breakdown for distribution to Sellers. Sellers then respond to the Buyer by sending Talent submissions online. The Buyer shortlists the Talent by sorting through the submissions, placing the actors submitted into three groups, A, B, or C, or omitting them from any group, and schedules Talent for upcoming auditions. The Buyer then contacts Sellers for Talent availability (scheduling). The Seller contacts Talent for their availability (scheduling). The Seller contacts Buyer with confirmations and regrets (scheduling). The Buyer posts sides and scripts for upcoming auditions (scheduling). The Seller distributes sides and scripts to auditioning Talent (distribution). The Buyer then shoots the audition session and uploads the video to the Buyer's (studio's) Castlist for the Project. The Buyer then distributes the audition sessions.

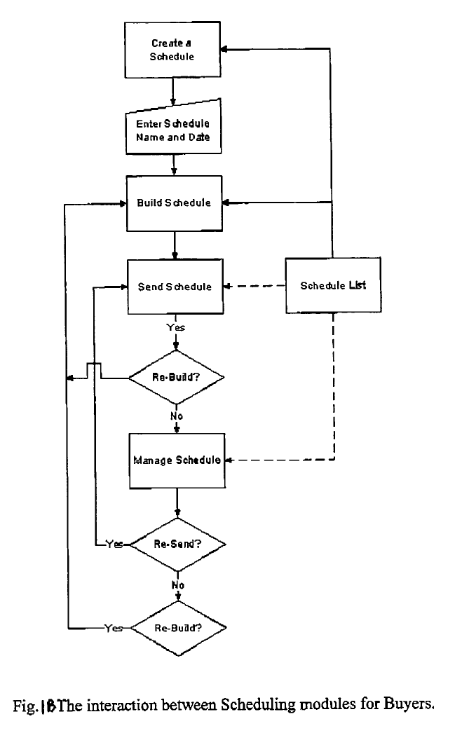

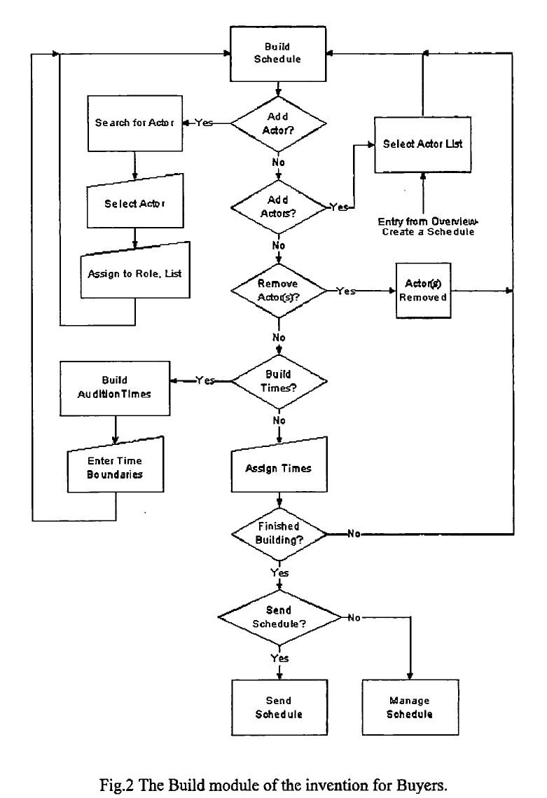

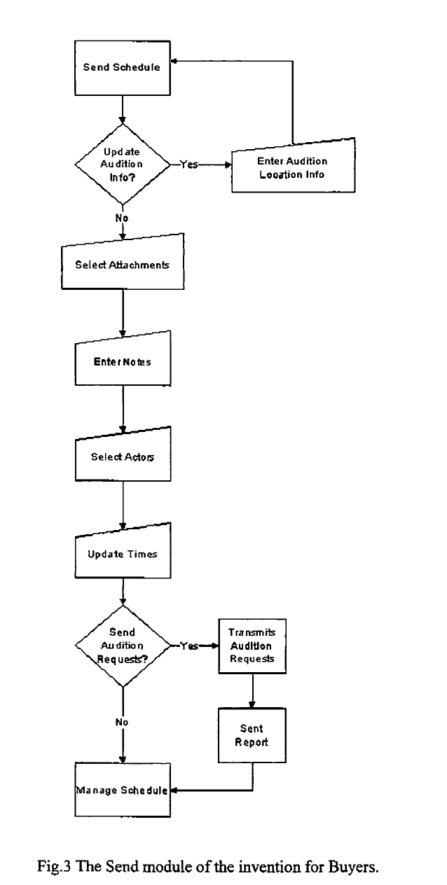

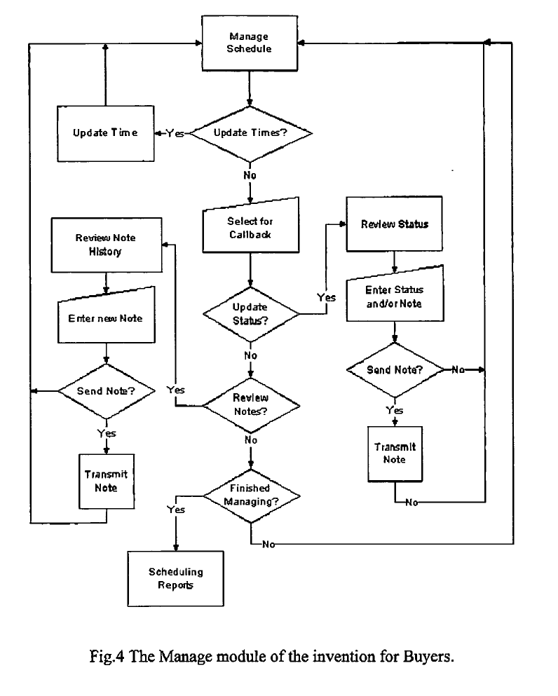

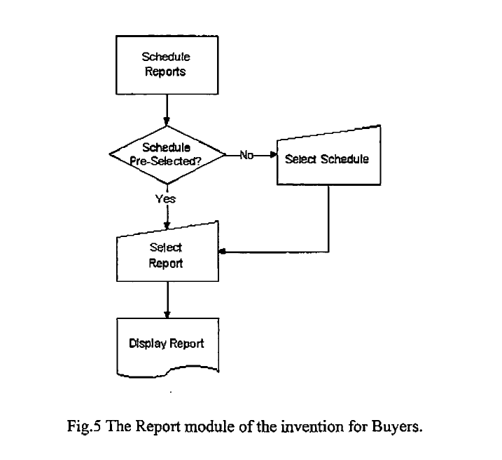

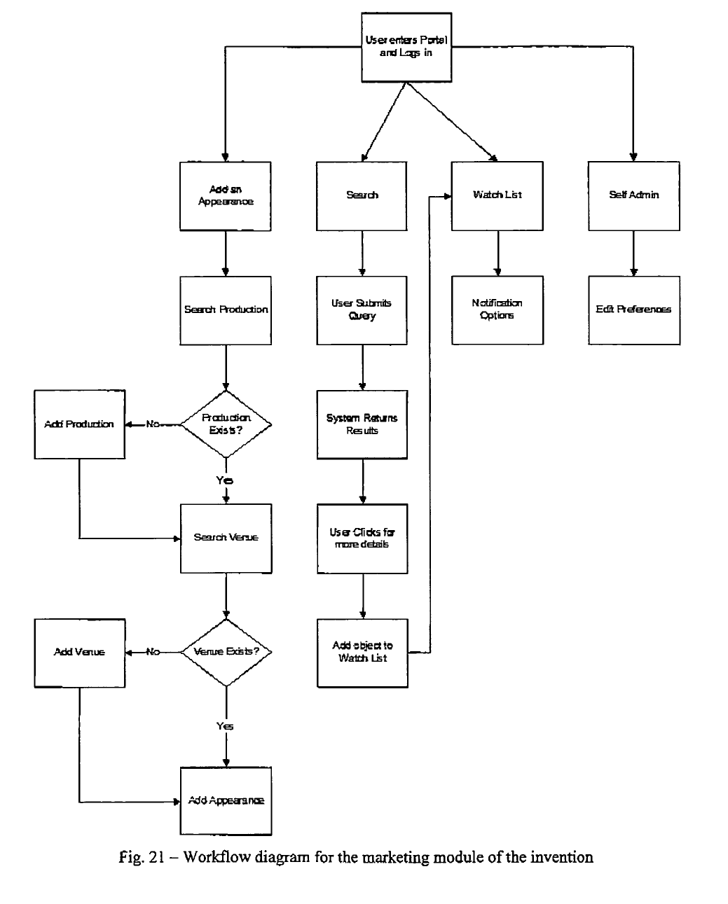

FIG. 1B outlines the interaction between scheduling modules for Buyers. The terminology that will be used is similar to the traditional method. In the Build stage (FIG. 2), a schedule is created by a Buyer or Seller, Actors are added to the schedule, the Actors are put in order, or sometimes grouped together, and audition times are created based on the order. In the Send stage (FIG. 3), audition times and supporting information are transmitted to Sellers and Actors. The sending and viewing of communication between the Buyers and Sellers is tracked in the Manage stage (FIG. 4). In the Manage stage, information about audition times, for example, confirmed, tentatively confirmed or regretted, is accessed and updated. In the Actor Manage stage, Sellers transmit audition times and supporting information to Actors, track the communication between themselves and Actors, and Buyers track the approval status of each audition time. In the Report stage (FIG. 5), the Buyer can view and print the audition schedule and track information, and supporting information, in various layouts and formats. In the Upload Session stage (FIG. 6), the Buyer can upload video, along with relevant information about the role and the Actor to the project and then distribute the information to executives. In the Marketing stage (FIG. 21), the Seller can notify other Buyers and the general public of the upcoming performance.

1. Schedule List

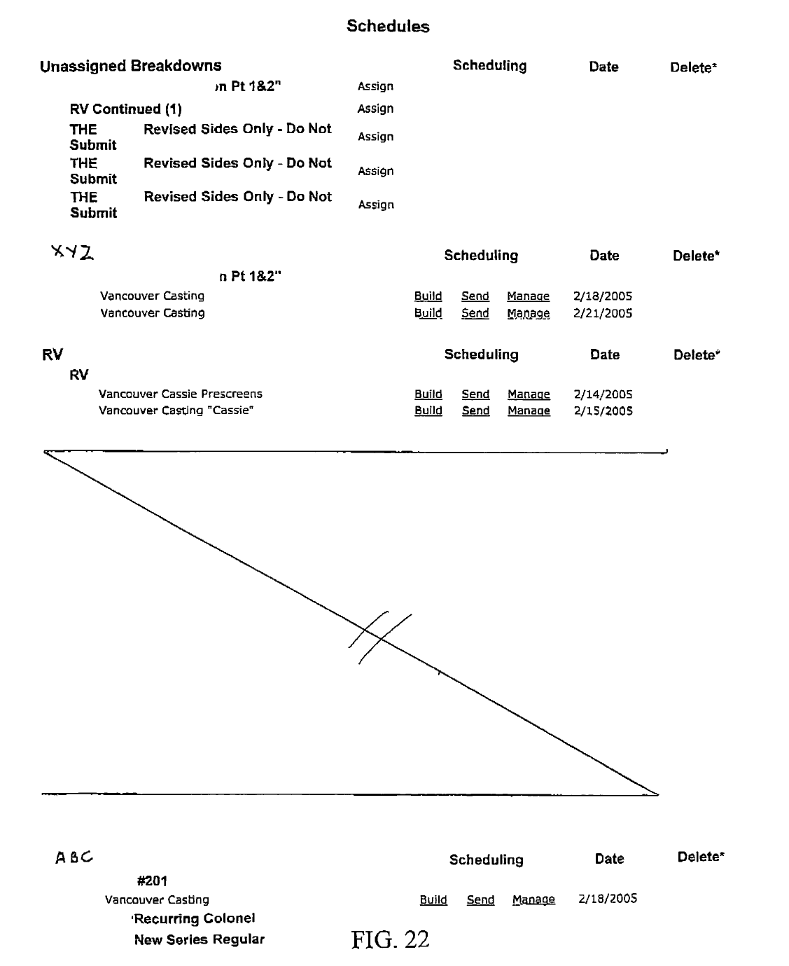

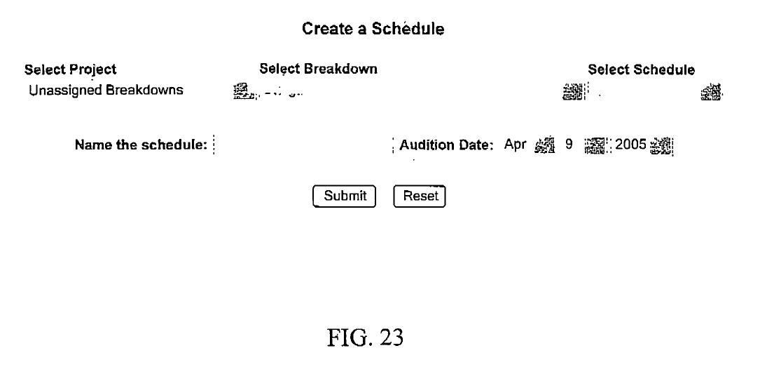

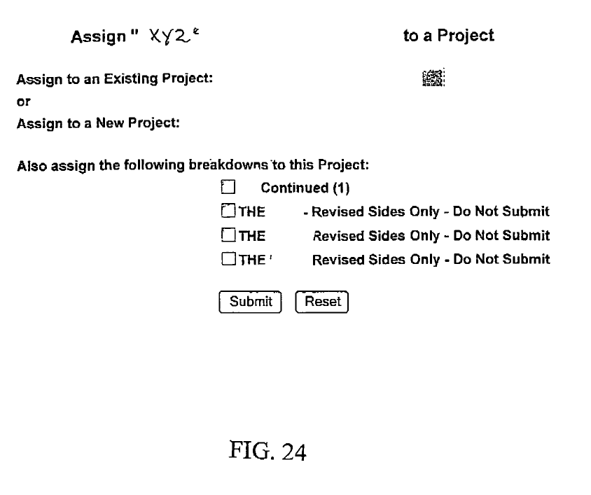

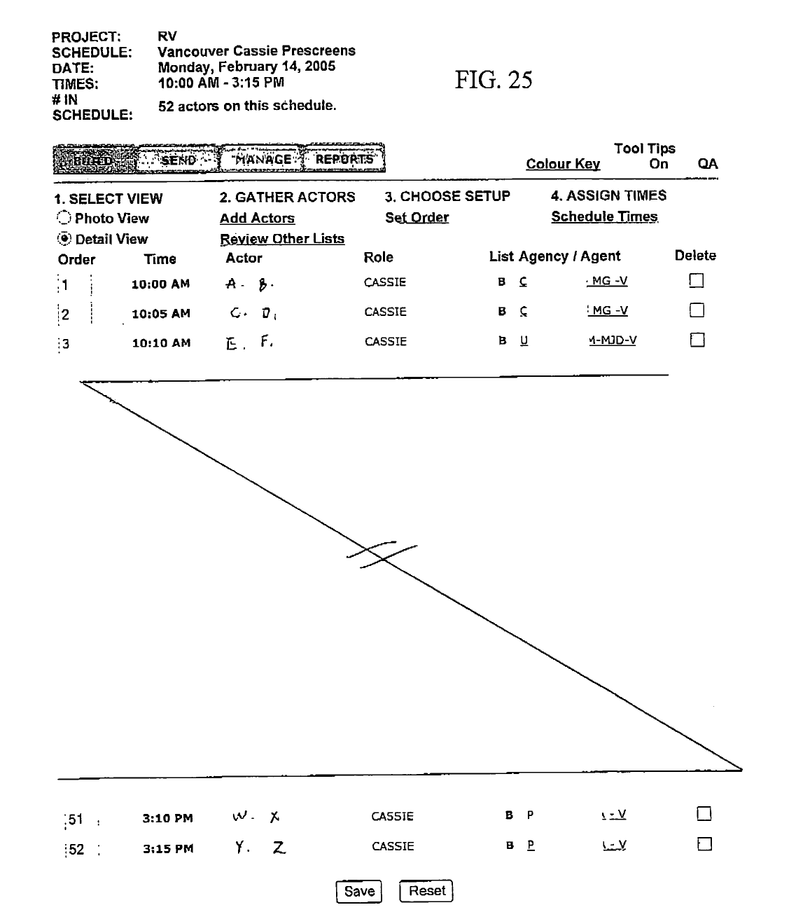

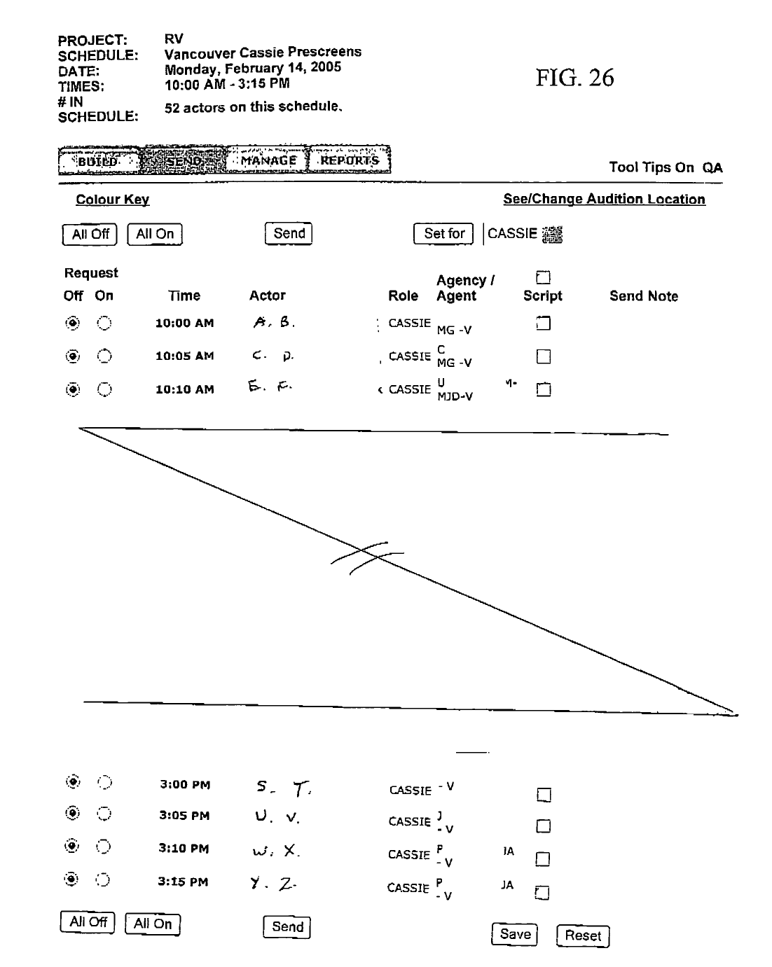

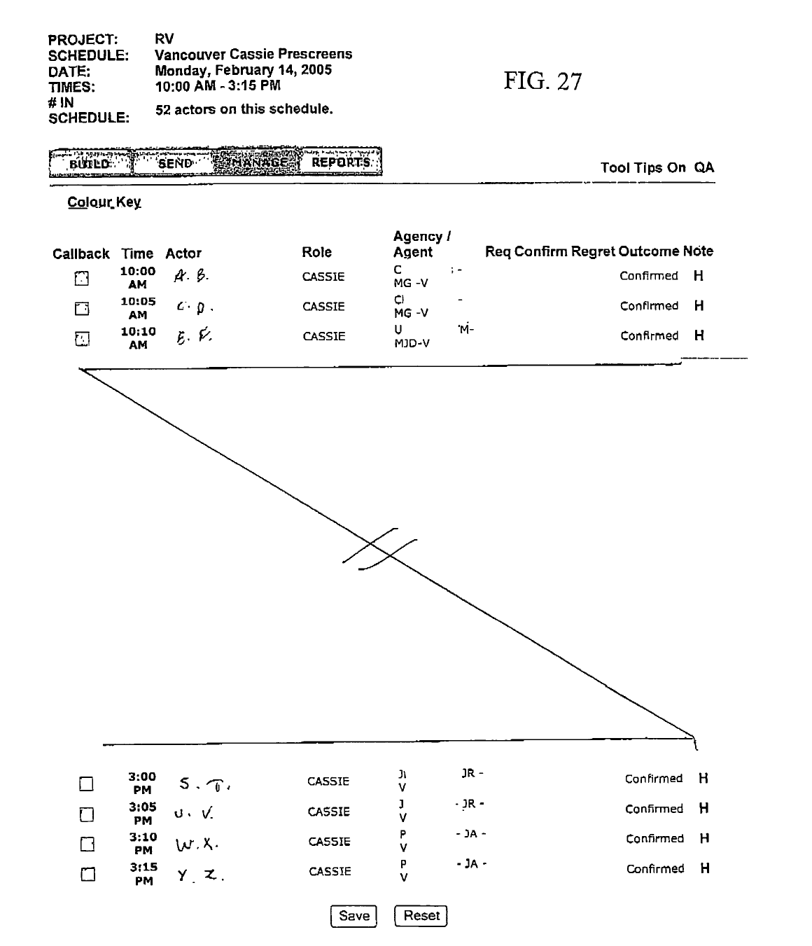

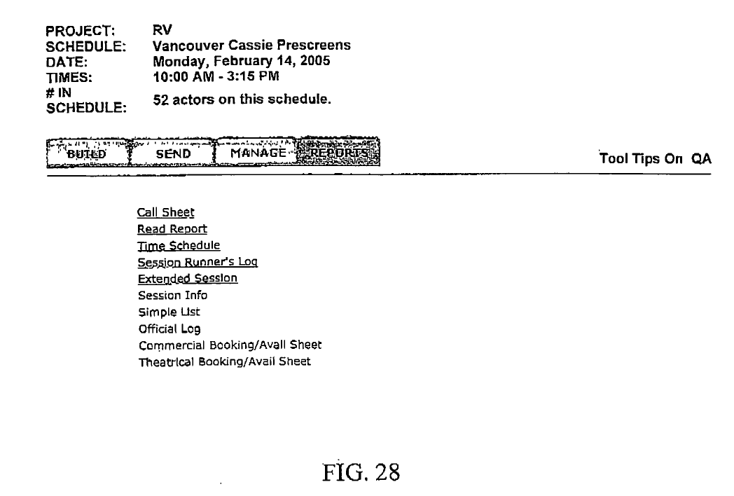

The Buyer acesses the portal web site 12 and logs in. The Buyer enters its unique login username and password. The system authenticates the Buyer and and presents the Buyer with a Welcome Page which lists current information on activity in the user's system. Current information from the Scheduling module is integrated into the Welcome Page. The Buyer can then choose to enter the Scheduling module and begins at the Schedule List page (FIG. 1B, FIG. 22) that lists existing schedules. The Buyer has six options available:
a. At any time, the Buyer can select a menu option to create a new schedule (FIG. 23). The Buyer is able to link the new schedule, to a previously existing project in the database or to a previously existing schedule for any project. The Buyer enters a name and date for the schedule and saves the schedule and then is seamlessly moved into the Build module and presented with the Select Actor List process, detailed below.
b. The Buyer can access the Build module of a previously existing schedule (FIG. 25) at any time detailed below. When at least one Actor has been added to the Schedule, the Buyer can access the Send (FIG. 26), Manage (FIG. 27), Upload Sessions and Reports (FIG. 28) modules from within the Build module.
c. After a Schedule is built, and at least one Actor has been added, the Send module becomes accessible for that schedule, detailed below. The Buyer can access any of the other modules from the Send module. A schedule can only be deleted until audition requests have been sent.
d. After a Schedule is built, and at least one Actor has been added, the Manage module becomes accessible for that schedule, detailed below. The Buyer can access any of the other modules from the Manage module,
e. After the Schedule is built, and at least one Actor has been added, the Upload Session module becomes accessible for that schedule, detailed below. The Bayer can access any of the other modules from the Upload Sessions Module.
f. The Buyer can also assign the Breakdown to a Casting Facility to act as a proxy for uploading the audition session (FIG. 24).

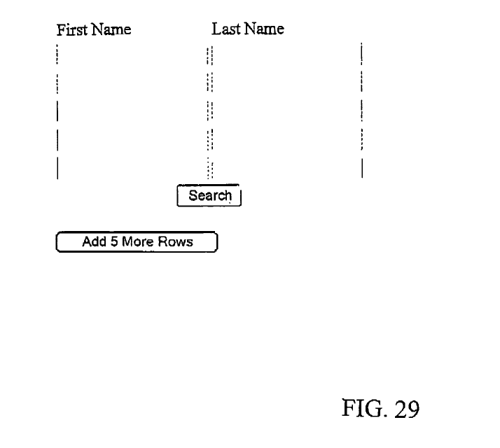

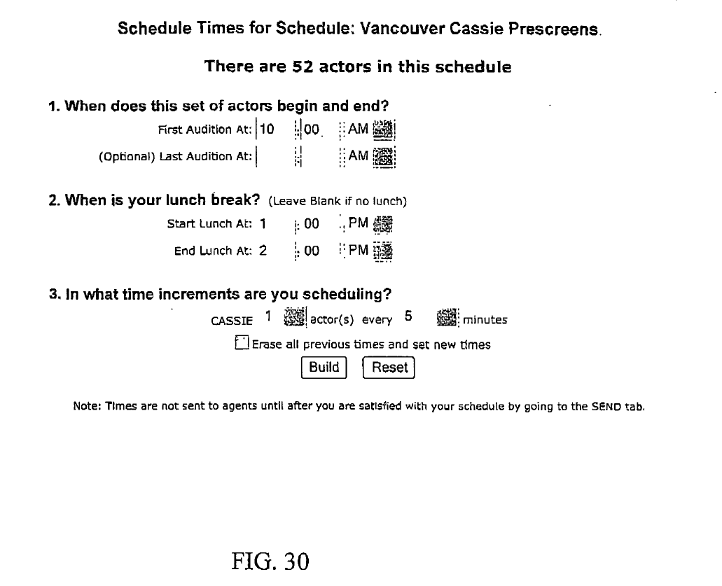

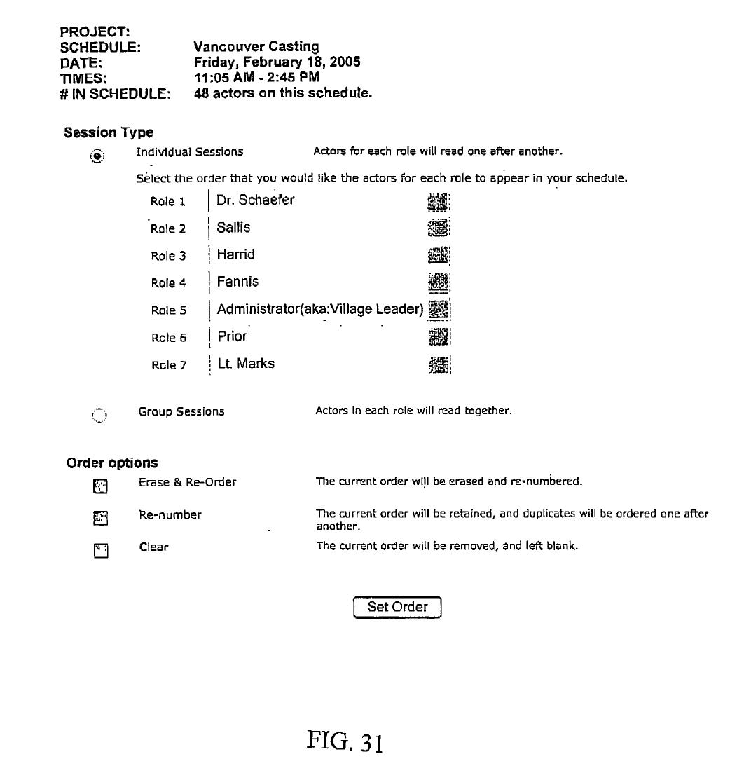

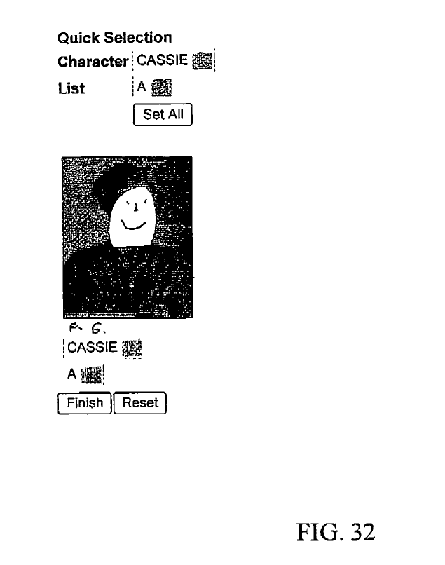

With reference to FIG. 2 and FIG. 25, this outlines the Building of a schedule. The Buyer can enter the Build module from any other existing module, or when completing the creation of a new schedule. Once in the Build module, the contents of the schedule are displayed for the Buyer to review. There are two layout options: a Detailed list format or a visual Thumbnail format that displays thumbnail photographs of the Actors in the schedule. From either layout, the Buyer can: 1) add more actors to the schedule either one at a time, or by groups; 2) remove actors from the schedule, 3) assign times for auditions or audition order for the actors; and 4) split a schedule into multiple audition schedules, as follows:
a. Add Actor—When clicked, the Add Actor link takes the Buyer to the Add Actors workflow (FIG. 29). Here the Buyer has a form to enter the first and last name of the actors, and to add more name fields if necessary. From the search results, the Buyer can select the Actor or add the Actor into the talent database. When a Buyer enters in a new Actor, they also select an Agent (Seller) for that Actor (see FIG. 32). From the selected list of actors, the Buyer selects a list of existing roles for the project for each actor. The Buyer selects a group label of A, B or C to put the Actor into, and can also select if the actors should be added to the schedule in a pre-defined order, or randomly. After the Buyer completes this process, the Buyer is returned to their default layout view in the Build module.
b. Review Lists of Actors—When selected, the Buyer is presented with the pre-assigned lists A, B or C used earlier for sorting submissions, and a list of other active breakdowns. If the Buyer selects a different breakdown, then the Invention, will change the submission lists. The Buyer can select a list or lists and the invention will add the Actors to the current schedule and fill holes in the list if requested. If the Buyer has selected a different breakdown, then the Invention provides a way for the Buyer to group roles from the new breakdown with roles in the current schedule, or to add the new roles into the current schedule. The Buyer is returned to the default layout view in the Build module.
c. Remove Actors—On both Build layouts, a “remove” or “delete” checkbox is available for each Actor on the schedule. If the Buyer checks a “remove” checkbox and saves the page, the checked Actor is removed from the schedule. If an audition request for a checked Actor has not been sent to the Actors' Agent (Seller), and there are no notes associated with the Actor, the Actor is deleted from the schedule. In the case where the Seller has created the schedule before the Buyer, the Actor is then hidden from the Buyer, but remains on the schedule for the Seller tools. If the schedule was transmitted to the Sellers, and the Buyer removes the Actor because they regretted, then the actor is hidden from the Buyer, but remains on the schedule and viewable to the Seller. The invention does provide the Buyer with the ability to take over any schedules created by the Sellers for ownership so the Buyer can create one master schedule to manage their auditions.
d. Assign Auditions Times Manually—From the Build page, the Buyer enters the auditions times next to the Actor's name and then saves the time into the database.
e. Assign Auditions Times Automatically or Build Times—Since there may be hundreds of Actors in a schedule, the task of manually assigning times to Actors is arduous. The invention provides a way for Buyers to allow the invention to create times for each Actor in the schedule after providing a few parameters. (FIGS. 30 and 31). The Buyer sets the audition start time; the number of actors to see at a time; the length of time for each auditions; and optionally, the last audition time of the day (not to be exceeded); and the start and end times for a lunch break. The Buyer sets the order in which different roles will be auditioned. The Invention then determines the audition times, and assigns them to the Actors in the schedule. If not all actors were able to be assigned times due to the restriction of the last audition time of the day (Audition End Time), then the invention will provide a warning message to the Buyer. If the actors in the schedule already have times assigned, the invention maintains those times unchanged, and only assign times to those actors currently unassigned to fill the holes in the schedule. There is an option for the Buyer to erase previously assigned audition times and re-assign audition times for all actors in the schedule. Once the invention completes the time assignments, the Buyer is presented with the default layout view in the Build module. Additionally, any warning messages from the invention are displayed.
f. Split Schedules—Some audition schedules are too long to be completed in one session. The Invention provides a way for Buyers to split one schedule into multiple schedules. The Buyer can assign audition times to a limited group of actors, and then move the remaining actors, those without audition times, to a new schedule. The Invention will automatically name the new schedule and set it for the day after the first schedule. The Buyer is still able to change the name or date of the new schedule, and can further split the new schedule if necessary.

After the Buyer finishes building the schedule, he/she can move to one of the other modules: Manage, Send, Upload Sessions, or Reports. With reference to FIG. 3 and FIG. 26, this outlines the Send module of Scheduling for Buyers. In the Send Schedule module, the invention electronically transmits the requests for an audition (“audition request”) and supporting information to the Sellers. In the Send module, the Buyer is presented with a page listing the actors in the schedule along with form elements to enter information and select supporting information to be attached to audition requests, and then prior to sending the audition requests the invention allows the Buyer to do the following:
a. The Buyer enters or attaches the following information to an Actor's audition request. For all options the Buyer can use form controls to enter information in the first field and it is applied automatically to all actors on the schedule, or to actors belonging to a certain role group, or the Buyer can enter information individually for each actor.
   i). Attachments—The Buyer can choose to attach information from the schedule's project, or an electronic version of the script, or an electronic version of selected script pages for the project.
   ii) Notes—The Buyer can type in a note for an individual Actor, or a note to go to all Actors belonging to a certain role, or to all Actors in the schedule.
   iii) Times—The Buyer can see and change the audition times for each Actor just prior to sending.
b. Send Request—The Buyer has the ability to mark specific Actors to only receive the audition request, or all Actors on the schedule.
c. Saving Selections—The Buyer has the option to save the page to store audition times, attachments, and notes in the database for later transmission.
d. Sending Audition Requests—When the Buyer clicks the Send button, the invention will then begin the transmission process. The invention will go through the schedule and for each Actor selected by the Buyer the invention will send an audition request message; and an email to the Seller containing information about the audition including the audition date, location, role, time and all the attachments selected by the Buyer. The invention will also mark the audition request as sent.

After transmitting the auditions requests the invention presents to the Buyer a report detailing which Seller received an email and those that did not. The Buyer can print this information as reference, and for those Sellers that did not receive an email, contact them by phone. From this report, the Buyer can go to the Manage module.

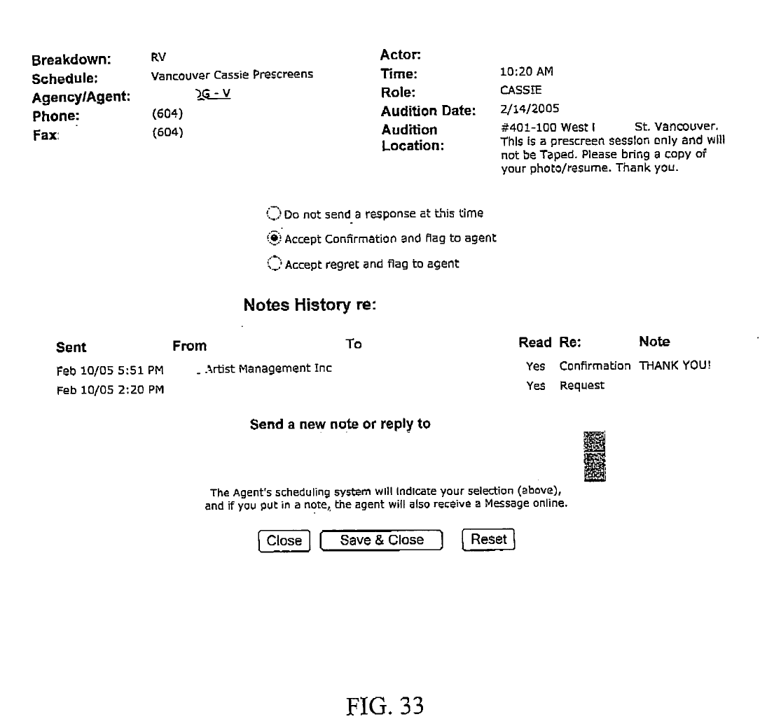

With reference to FIG. 4 and FIG. 27, this outlines the Manage module of Scheduling. The Manage module presents to the Buyer the tracking information of the auditions requests as the Sellers respond. The Buyer can enter this module from any other existing module or the Schedule List page. The Buyer also has the following options in the Manage module:
a. Update Times—The audition time for the Actor is displayed on but is not editable on the Manage page. The Buyer can change the audition time by clicking on the displayed time, which is a link. A new page is presented to the Buyer with the time displayed in form elements. The Buyer changes the time, and clicks the Save button. The invention updates the audition time and sends an updated message to the Seller. The Buyer is then returned to the Manage page that displays the updated information.
b. Select for Callback—There is a form checkbox available for each Actor in the schedule for Callbacks. Once the auditions are completed, the Buyer can come to the Manage module and select the Callback checkboxes for all actors that they wish to return for a second audition. After pressing the save button, this information is stored in the database. When the Buyer creates a new schedule for the breakdown, the current schedule will be available as a template for a new schedule and when the Buyer is selecting lists of actors for the new schedule, those actors selected for Callback will be available for selection, grouped by role.
c. Update Status—On the Manage page, the current status of the audition requests are displayed. There are five possibilities for the current status of the audition request: 1) Request Sent; 2) Pending Confirmation; 3) Pending Regret; 4) Confirmation; and 5) Regret. The Buyer clicks on the displayed status text to open a new page (FIG. 33) to select the new status of the audition request for that actor. On this page a chronological history of all notes sent between the Buyer and Seller are presented. The Buyer also has the ability to enter in private notes about the Actor that are only seen by the Buyer. After the Buyer clicks save, the new status, along with any notes, private or to the Seller are saved in the database. The page closes and the status on the Manage page is updated. If a note was entered for the Seller, the note was entered into the messaging system and an email was sent to the Seller.
d. Review Notes—If notes have been sent between the Buyer and a Seller, an “H” will be displayed on the row of that Actor's audition. If there is a note from the Seller, that hasn't been read by the Buyer then a “Q” will display instead of the “H”. The Buyer clicks on the display text to open a new page that will show a complete chronological history of all notes sent between the Buyer and the Sellers along with a form text box for the Buyer to type in a new note, if desired. If the Buyer enters a note and presses the Save button, then the note is sent to the Seller via messaging and the Buyer is returned to the Manage module page, which displays the updated information, This is the same page (FIG. 33) as previously described when the Buyer wants to change the status (confirm regretted) of an audition request.

At any time the Buyer can go to the Reports module to generate reports on the schedule while in progress or when it's finished. With reference to FIG. 5 and FIG. 28, this outlines the Report module of Scheduling. The Buyer can enter the Report module from any other existing module, or the Schedule menu. If the Buyer enters the Report module from the menu, the invention presents to the Buyer a list of active schedules and the different reports available. After making the selections, the Buyer clicks the Run button and the invention presents the Buyer with the formatted report. When finished with the Report the Buyer can select a scheduling option from the scheduling menu. The system can generate the following reports:

A) Project Reports

Breakdowns Report. Print view of the breakdown
Submission Report. A list of all Submissions made for this Breakdown (same as Review, print view)
Audition Report. List of confirmed actors on the schedule(s) for the break-down/project
Callbacks Report. List of all actors marked for “callback” on the schedule(s) for the breakdown/project
Interest Report. List of all actors marked for “interest” on the schedule(s) for the breakdown/project
Bookings Report. List of all actors marked as “booked” on the schedule(s) for the breakdown/project
Notes Report. All notes for this project/breakdown/session/listed with most recent at the top including sender,
Deal memos Report. List of all deal memos for this project/breakdown/session each linked to the print view for each deal memo
Check authorizations Report. Lists all checks authorized for printing.
Residual authorizations Report. Lists all residual payments authorized for printing.
Payments Report. Lists Payments received and outstanding.
   B) Talent Reports
Bookings Report. All bookings for this client listed by project name and each name linked to the print view
Client Details Report. All stored information for this client on their profile
Client Contacts Report. All contacts for this client including SIN or SSN if input
Client Quotes Report. All quotes for this client as input with a date of entry and most recent at the top
Payments Report. All payments due this client as calculated from the deal memo and relevant calculations for region etc.
O/S Payments Report. All outstanding payments for this client as above,
Air Dates Report. All known airdates either input by agent or pulled from now appearing for this client
   C) Seller Reports
Commissions Report. All commissions for this agent based upon existing deal memos and calculated percentages
Bookings Report. All bookings for this agent as marked by the agent

With reference to FIG. 6, this outlines the Upload Session module of Scheduling for Buyers. In the Upload Session Module, the Buyer is presented with the Actors in the order or time they are to be seen. Auditions are digitally videotaped and the videos are placed on a server in the Buyer's office, or if the Buyer uses a Casting Facility, then the Casting Facility's servers. The video files are systematically uploaded to the invention's FTP web server. This can be done through a watch folder or manually. A watch folder is a folder that is being “watched” by a third party application that will automatically FTP files to a server at specific intervals or when a new file is placed in the folder. The Buyer or Casting Facility uses the invention to record the seen order of the Actors as they come in for their auditions. They also enter in the title of the audition video (i.e. “Take 1”), the length of video (i.e. 3 minutes) and the name of the file that was uploaded or will be uploaded to the invention's FTP server. The Buyer can also enter notes regarding the Actor that they wish to tell the executive or viewers of the videos, plus they can make their “picks” or “choices” to indicate to the executives which actor they would select for the role or for a second audition.

If all the audition videos are present on the FTP server, the Buyer selects the option to transfer the files to the Project Module (which is the subject of co-pending U.S. provisional patent application Ser. No. 60/576,311 filed Jun. 3, 2004, entitled Method and System to Manage Studio Casting Projects which is pending and is incorporated herein by reference) immediately after entering the information. Otherwise, they are given the option to save the information or to schedule an upload for a later time. If the Buyer chooses to schedule an upload for a later time, the Buyer selects a time when all the files will be present on the FTP Server. Scheduling an upload allows the Buyer to enter in the information about the videos and then go home for the evening instead of waiting for each video to be uploaded. A report is generated and notification sent by email to the uploader; and in the cast of a Casting Facility, the Buyer notifying them that the upload is complete with a link to a report on the success and failure of the uploads. After the videos have finished transferring to the Project Module, the Buyer uses that invention's methods for distributing the videos to executives.

Occasionally, Buyers use a Casting Facility's studios to have the auditions and to tape the auditions. The invention allows the Buyer the ability to assign a Casting Facility to act as their proxy. Using a separate account, the Casting Facility can do everything the Buyer can do. They can enter in scene order, video title and file name; schedule an upload; and upload immediately. The Buyer and the Casting Facility can share, so the Buyer can enter in pertinent information and the Casting Facility can deal with the schedule of the upload so the video files are transferred.

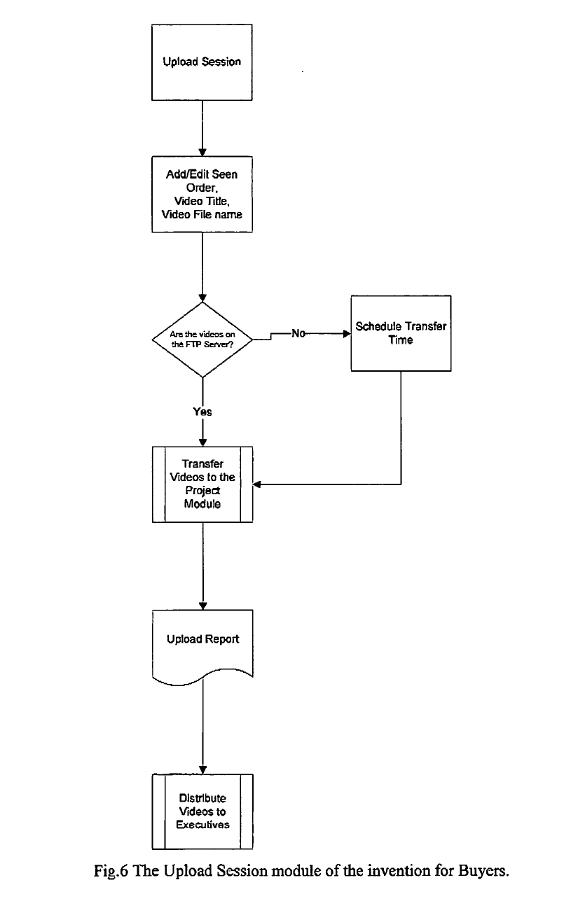

A Seller has its own specific set of tools to manage audition times for their Talent, as described in FIG. 7-19. Web pages are displayed to Sellers during the operation of the invention to carry out these functions in the same way as was described for Buyers above. Sellers also have their own distribution system for Talent to receive the supporting documents. Sellers receive an email of audition requests that includes a link to a secure website. All Sellers, regardless of their account status, can view the audition request and confirm or regret the audition request. The moment the Seller views the audition request, the Buyer is notified that the Seller has received the request and has read it. The Seller can also write a note to the Buyer using the internal messaging system, and as previously described the Buyer will be notified immediately. Should the Buyer not use the invention to manage their audition schedules, the Seller can enter audition times for their Talent using the invention, and the invention will create a schedule for the Buyer. If more than one Seller enters in the same audition date, role and project, the invention will continue to add to the first schedule it finds so the Buyer need not see many individual schedules. The Seller can automatically send an email notification to the Talent the moment the request is received. They can also send supporting documents and have a record of what was sent, and how many times, electronically. When the Talent reviews their notification or opens the supporting documents, the Seller is notified that Talent has received and read the notification. The Talent can also leave notes to the Seller regarding this audition. This note is private between the Seller and the Talent and not viewable to the Buyer, whereas the notes between the Sellers and the Buyer's are also private, and not viewable to the Talent.

With reference to FIG. 7, this outlines the integration of the Scheduling Invention with the Seller login to the Casting Workbook website.
1. Seller Login. The Seller enters their unique login username and password to the existing Casting Workbook.com website. The system authenticates the Seller and present the Seller with a Welcome Page
2. Welcome Page. The Welcome page lists current information on activity in the user's Casting Workbook system. Current information from the Scheduling module is integrated into the Welcome Page and lists the counts of new communications from Buyers listed by project and schedule. The Seller can click on any count to enter the Project Grid with the details for the selected new counts displayed, The Seller can also choose to enter a project listing from the main menu. The Seller can also choose to enter any of the other pre-existing Casting Workbook modules
3. List Active Projects. This page lists currently active projects for the user in the Casting Workbook. The Scheduling Invention is integrated into the projects lists. Scheduling information and links into scheduling for each project is displayed with the project. The Seller can click on any of the displayed scheduling information to enter the Project Grid with the selected information displayed. The Seller may choose to enter the Scheduling Invention through the main menu, and the Invention displays the Large Grid listing all the scheduling items for active projects to the Seller. The Seller may also choose to enter any other module of the Casting Workbook via the main menu.

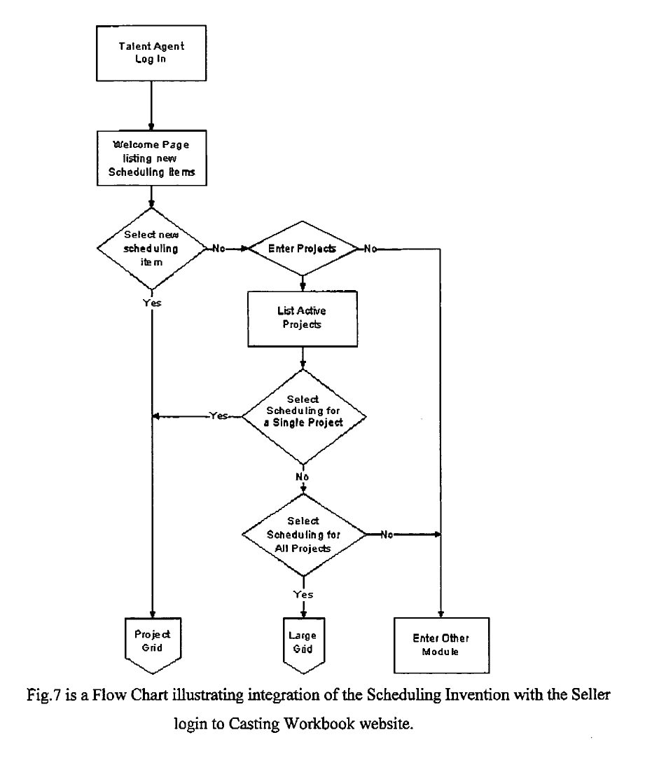

With reference to FIG. 8, this outlines the Large Scheduling Grid which displays details on any auditions being scheduled from the current date onward. Sellers see related project information, and the current status of communications between Seller and Buyers and between Sellers for each active audition request. The Grid can be sorted by any column by clicking the column title. The Seller can perform the following functions:
1. Enter single Project Grid. The Seller can click on any project title displayed and the Invention will move the Seller to the Project Grid, displaying all current audition requests for all schedules belonging to the selected project.
2. Enter single Talent Grid. The Seller can click on any Talent's name displayed and the Invention will move the Seller to the Talent Grid, displaying all current audition requests for all schedules belonging to the selected Talent.
3. Take Action. The columns “Casting Requests”, “Talent Calls” and “To Casting” each display current status messages to the Seller indicating the various communication statuses between the Seller, Buyer and Talent. The Seller can click on any of the status indicators to load the Take Action page, to update status information or send notes to the Buyer or Talent.
4. View Notes. The “Notes” column displays status indicators to inform the Seller of the history of notes related to each audition request. A “?” is displayed if there are any notes sent to Seller that has not been read. An “H” is displayed if there are any notes sent to Seller but none that are not yet read. The Seller can click on “?” or an “H” and the Invention will open the Notes History page.
5. Remove Request. The “Remove?” column contains a form checkbox for each audition request. The Seller can select any checkbox and click a “Remove Selected” form button at the bottom of the Grid. The Invention will evaluate the audition request for each selected checkbox. If the schedule that a selected audition request belongs to is set to allow the Seller access and there are not any notes in the integrated Messaging system related to the selected audition request, the Invention will delete the audition request from the database. If all these conditions are not met then the system will update the audition request record to indicate to hide the record from the view from the Seller on any scheduling grid or report. This enables the record to continue to be used by the Buyer.

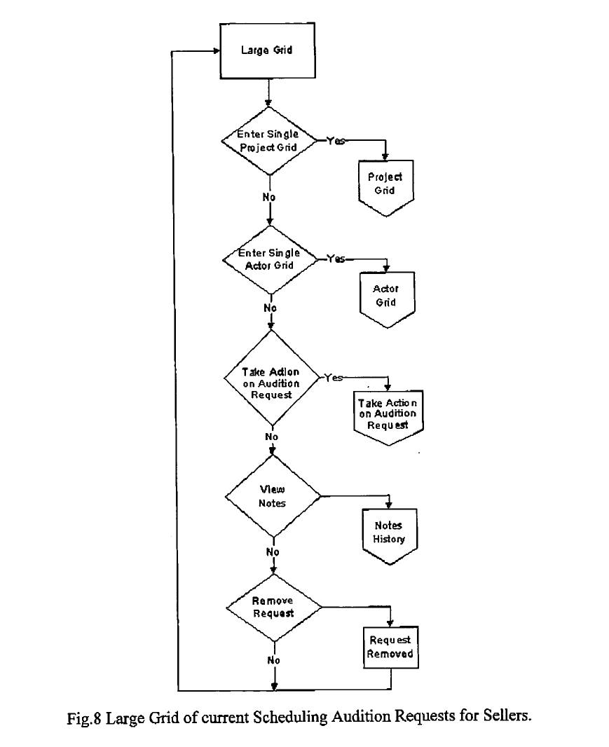

With reference to FIG. 9, this outlines the Grid of current Scheduling Audition Requests for a single Talent for a Seller. It displays details on any auditions being scheduled from the current date onward for a single Talent. Sellers see related project information, and the current status of communications between Seller and Buyers and between Sellers and Talent for each active audition request along with current contact information for the Talent. The Grid can be sorted by any column by clicking on the column title. The Seller can perform the following functions;
1. View Talent Contact Information. The Seller clicks on the Talent's displayed preferred contact information and the Invention will present the Seller with the Talent Contact Info page, displaying all contact information for the selected Talent and allowing the Seller to add or update contact information and select the primary contact method for the Talent.
2. Take Action. The columns “Casting Requests”, “Talent Calls” and “To Casting” each display current status messages to the Seller indicating the various communication statuses between the Seller, Buyers and Talent. The Seller can click on any of the status indicators to load the Take Action page, to update status information or send notes to the Buyer or Talent.
3. View Notes. The “Notes” column displays status indicators to inform the Seller of the history of notes related to each audition request. A “?” is displayed if there are any notes sent to Seller that the Seller has not yet read. An “H” is displayed if there are notes sent to Seller but none that are un-read. The Seller can click on “?” or an “H” and the Invention will open the Notes History page

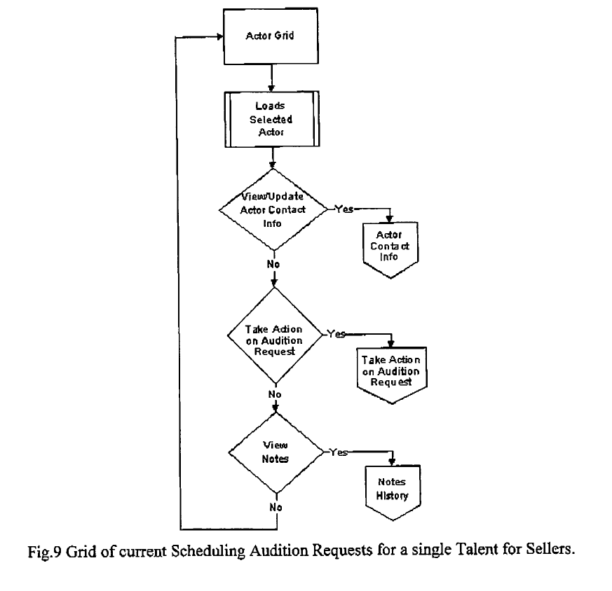

With reference to FIG. 10, this outlines the Review page of Scheduling worksheets for a single Project for Sellers. It displays a report formatted for convenient printing which contains the Seller's name, address and, if present in the Casting Workbook, the Seller's logo. It then displays the title of the selected project, and each role or character in the project and the gender, and age range for the role. It also displays the names of the Talent that were submitted to each role by the Seller. The Seller has the option via a displayed set of sub-menus to enter different worksheets for the currently active project, which are Talent Calls, Project Grid, Send Materials and Reports, each detailed below.

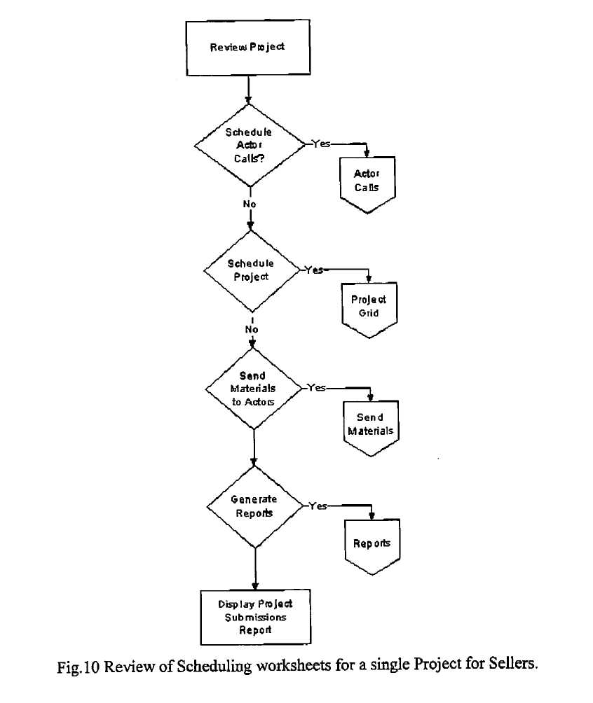

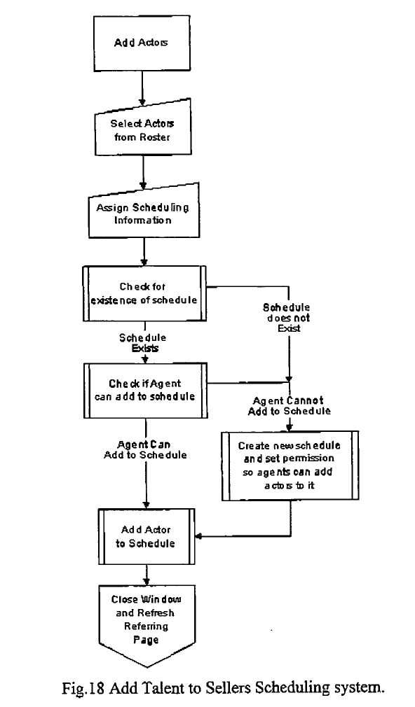

With reference to FIG. 11, this outlines the management of the Talent Calls page on worksheets for a single project in the Scheduling Invention for Sellers. It displays details on any auditions being scheduled from the current date onward along with all Talent submitted for consideration for audition but not yet chosen. Sellers see related project information, and the current status of communications between Seller and Buyers and between Sellers and Talent for each active audition request along with the current preferred contact information for each Talent. The Grid can be sorted by any column by clicking on any column title. The Seller can perform the following functions:
1. Edit Audition Information. If a row on the report is an audition request belonging to a schedule that has access set to allow editing by the Seller, or a Talent submitted for consideration for an audition, but not yet requested, then an “Edit” link appears for that row.
   a. If the Seller clicks on the “Edit” link, the Invention display a form fields for the selected record containing an Audition Date, Time, Role, Location and checkbox indicating the Invention is to confirm with the Talent. The “Edit” link will be replaced by an “Update” link.
   b. After entering information, the Seller can click the “Update” link and the Invention will add an audition request to a current schedule for the selected project and role.
   c. If the current schedule does not allow editing by the Seller, or a current schedule does not exist, then the Invention will create a new schedule for the audition request and set it to allow editing by Sellers, and the schedule will also be viewable and editable by Buyers.
   d. If the Seller had selected the checkbox to confirm with the Buyer, then the Buyer will be informed on the Buyer welcome page, project list page, and scheduling pages of the new audition request from the Seller.
2. Enter single Talent Grid. The Seller can click on any Talent's name displayed and the Invention will move the Seller to the Talent Grid, displaying all current audition requests for all schedules belonging to the selected Talent.
3. Take Action. The columns “Casting Requests”, “Talent Calls” and “To Casting” each display current status messages to the Seller indicating the various communication statuses between the Seller and Buyers and Talent. The Seller can click on any of the status indicators to load the Take Action page, to update status information or send notes to related Buyers or Talent.
4. View Notes. The “Notes” column displays status indicators to inform the Seller of the history of notes related to each audition request. A “?” is displayed if there are any notes sent to Seller that the Seller has not yet read. An “H” is displayed if there are notes sent to Seller but none that are un-read. The Seller can click on “?” or an “H” and the Invention will open the Notes History page.
5. Add from Roster. A link a the top of the Talent Calls page gives Sellers the ability to add new Talent to the Talent Calls list. The Add Talent functionality is detailed in FIG. 18.
6. The Seller has the option from a set of sub-menus to enter different worksheets for the currently active project, which are Review, Project Grid, Send Materials and Reports, each detailed in other Figures.

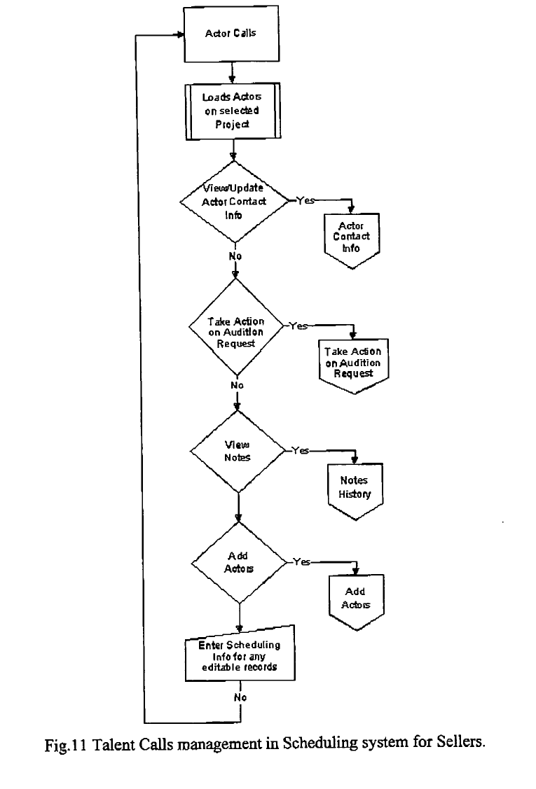

With reference to FIG. 12, this outlines the Scheduling single Project Grid of current Audition Requests for Sellers, which displays details on any auditions being scheduled from the current date onward for the current selected project. Sellers see related project information, and the current status of communications between Seller and Buyers and between Sellers and Talent for each active audition request, along with the current preferred contact information for each Talent. The Grid can be sorted by any column by clicking on the column title. The Seller can perform the following functions;
1. Enter single Talent Grid. The Seller can click on any Talent's name displayed and the Invention will move the Seller to the Talent Grid, displaying all current audition requests for all schedules belonging to the selected Talent.
2. Take Action. The columns “Casting Requests”, “Talent Calls” and “To Casting” each display current status messages to the Seller indicating the various communication statuses between the Seller and Buyers and Talent. The Seller can click on any of the status indicators to load the Take Action page, to update status information or send notes to related Buyers or Talent.
3. View Notes. The “Notes” column displays status indicators to inform the Seller of the history of notes related to each audition request. A “?” is displayed if there are any notes sent to Seller that the Seller has not yet read. An “H” is displayed if there are notes sent to Seller but none that are un-read. The Seller can click on “?” or an “H” and the Invention will open the Notes History page.
4. Remove Request. The “Remove?” column contains a form checkbox for each audition request. The Seller can select any checkbox and click a “Remove Selected” form button at the bottom of the Grid. The Invention will evaluate the audition request for each selected checkbox. If the schedule that a selected audition request belongs to is set to allow Seller access and there are not any notes in the integrated Messaging system related to the selected audition request, then the Invention will delete the audition request from the database. If all these conditions are not met then the system will update the audition request record to indicate to hide the record from view from the Seller on any scheduling grid or report. This enables the record to continue to be used by the Buyer.
5. The Seller has the option via a displayed set of sub-menus to enter different worksheets for the currently active project, which are Review, Project Grid, Send Materials and Reports, each detailed in other Figures.

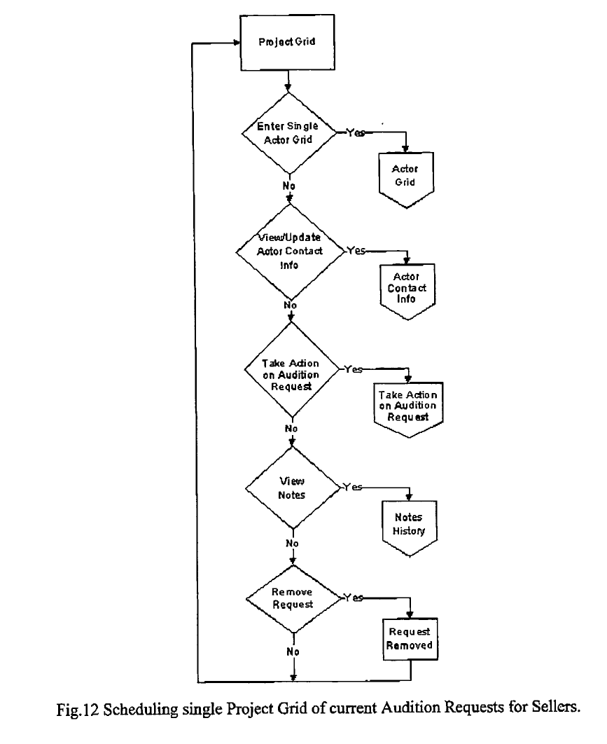

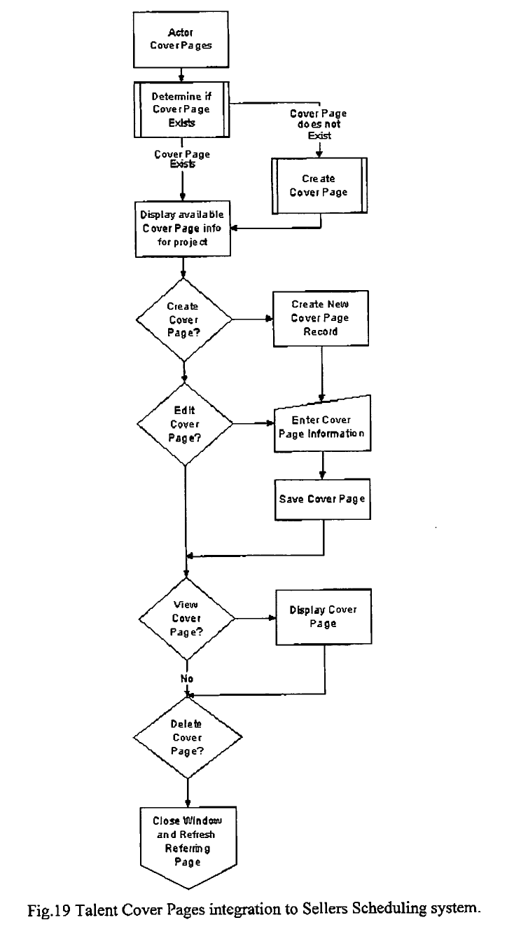

With reference to FIG. 13, this outlines the Send Materials management in Scheduling system for Sellers, which displays details on any auditions being scheduled from the current date onward for the current selected project. Sellers see the Talent's name and the current preferred contact information, the role being auditioned for, the Seller's current Talent Follow Up note, along with form checkboxes to indicate to include various materials in messages sent and a form text box for the Seller to type a unique note. The Seller can perform the following functions:
1. Add from Roster. A link a the top of the Talent Calls page give Sellers the ability to add new Talent to the Talent Calls list. The Add Talent functionality is detailed in FIG. 18.
2. The Seller has the option via a displayed set of sub-menus to enter different worksheets for the currently active project, which are Review, Project Grid, Send Materials and Reports, each detailed in other Figures.
3. View or Update Cover Pages. If the Seller clicks the link labeled “*You must modify role only breakdowns prior to sending” then the Invention opens a new window and presents the Seller with the Cover Sheet list. Its functionality is detailed in FIG. 19.
4. View Talent Contact Information. The Seller can click on the Talent's displayed preferred contact information and the Invention will present the Seller with the Talent Contact Info page, displaying all contact information for the selected Talent and allowing the Seller to add or update contact information and select the primary contact method for the Talent.
5. Select Materials to Send to Talent. The Send Materials page a column for five different materials. Each column contains a checkbox for each audition request listed on the page and if materials have been previously sent to the Talent related to the audition request then a “Sent” message is displayed along with then number of times the material has been sent. The Seller can select any box to have the Invention send the materials indicated in the column to the Talent related to the audition request. The material types are:
   a. Full Breakdown. This material contains all the project information entered and managed in the integrated Breakdown module of the Casting Workbook for the selected project.
   b. Role Only. This material indicates a Role Cover Sheet. Its contents are managed by the Seller in item 3 above.
   c. Full Script. This material indicates a PDF file of the script for the project, which is managed and stored in the integrated breakdowns system from the Casting Workbook for the selected role.
   d. Sides—All Roles. This material indicates multiple PDF files of selected scripts or “sides” for all roles in the project, which is managed and stored in the integrated breakdowns system from the Casting Workbook.
   e. Sides—Role Only. This material indicates a PDF file of selected scripts or “sides” for the role related to the audition request, which is managed and stored in the integrated breakdowns system from the Casting Workbook.
6. Include Note to Talent. The final column in the Send Materials page provides the Seller with a form text box for each audition request. Any notes the Seller enters in a Note box will be sent to the Talent, along with the selected materials to the Talent related to each audition request.
7. Send. A Send button is provided to the Seller. When clicked, the Invention will send the notes and materials for each Talent related to each audition request as follows.
   a. A message in the Messaging system in the integrated Casting Workbook will be prepared.
   b. If Full Breakdown was selected for the audition request then the Invention will attach the contents of the integrated breakdown from the Casting Workbook to the Message being prepared.
   c. If Role Only materials were selected for the audition request, the Invention will check for the existence of a Cover Sheet for the role. If no Cover Sheet exists the Invention will provide a page to the Seller with this information and requesting that the Seller create a Cover Page. If the Seller clicks the button to create a cover page, then the Invention will create a Cover Page and continue processing the Message. If the Seller indicates not to create a Cover Sheet, then the Send process is halted and the Seller is presented with the Send Materials page again.
   d. If Full Script was selected for the audition request then a link will be attached to the Message to allow the Talent to access the appropriate PDF file from the integrated Artists Workbook website.
   e. If Sides—All Roles was selected for the audition request then a link will be attached to the Message to allow the Talent to access the appropriate PDF files from the integrated Artists Workbook website.
   f. If Sides—Role Only was selected for the audition request then a link will be attached to the Message to allow the Talent to access the appropriate PDF file from the integrated Artists Workbook website.
   g. If a Note was entered for the audition request, then the text of the note will be inserted in the integrated Message.
   h. The Invention will retrieve the current email address for the Talent related to the audition request from the client database in the Casting Workbook and the integrated Message will be sent to the Talent for the Talent to access via the Talent's Workbook website. The Message will also be formatted and emailed to the Talent.
   i. After sending all the Messages, then Invention will provide the Seller with a page reporting the results of the Messages sent A link will be present on the report, for the Seller to click, to return to the Send Materials page, or the Seller can select any menu item.

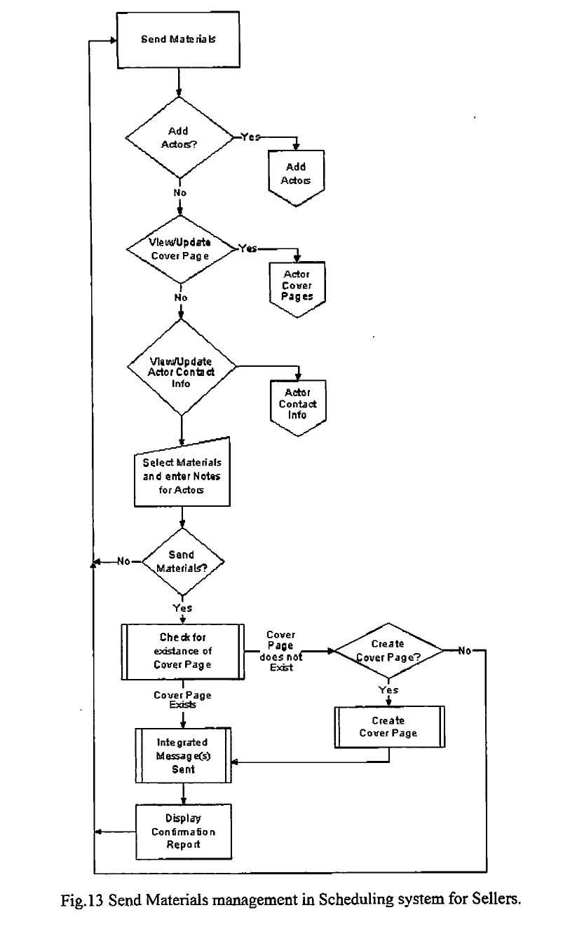

With reference to FIG. 14, this details the Reports management in Scheduling system for Sellers displays details on reporting options for the currently selected project. The Seller can select from three report types—Client, Project or Seller. The Seller selects either the project selected or one or more of any schedules that are related to the project. Then the Seller clicks the Report button. The Invention generates the report and presents it to the Seller. The Seller can view and print the report, and click the Report menu sub-menu button to return to the previous Reports page, or can click on any other menu item.

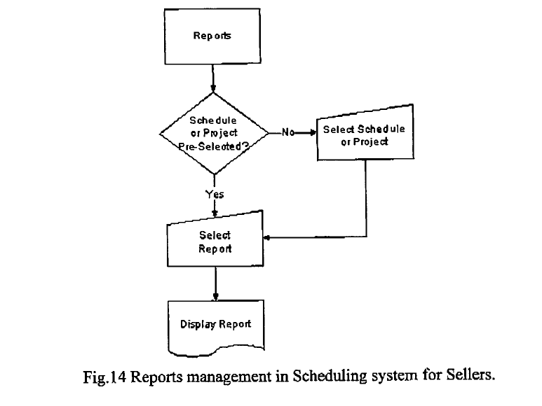

With reference to FIG. 15, this details the Take. Action method in Scheduling system for Sellers. This page is accessed from various pages in the scheduling Invention. It is provided with a unique audition request. It then provides the Seller with information in four sections from scheduling and also integrated information from the Casting Workbook, for the unique audition request, as follows:
1. It displays integrated project, role and scheduling information about the audition request.
2. It displays the current Talent Call status, and the option for the Seller to change the Talent Call status, and a text box to enter a note to send to the Talent related to the audition request.
3. It displays the current Buyer communication status, and the option for the Seller to change the Buyer communication status, and a text box to enter a note to send to the Buyer related to the audition request.
4. It provides an addition text box for the Seller to enter internal notes for Talent Follow-up which appears on the scheduling Grid pages, as a reminder to the Seller of tasks still needing to be completed.
5. A form button, labeled “Done” is provided. When the Seller presses this button the status changes or Talent Follow Up notes made by the Seller are saved, any Buyer or Talent notes entered by the Seller are sent to their intended recipients via the integrated Casting Workbook Messaging, and the page is closed.

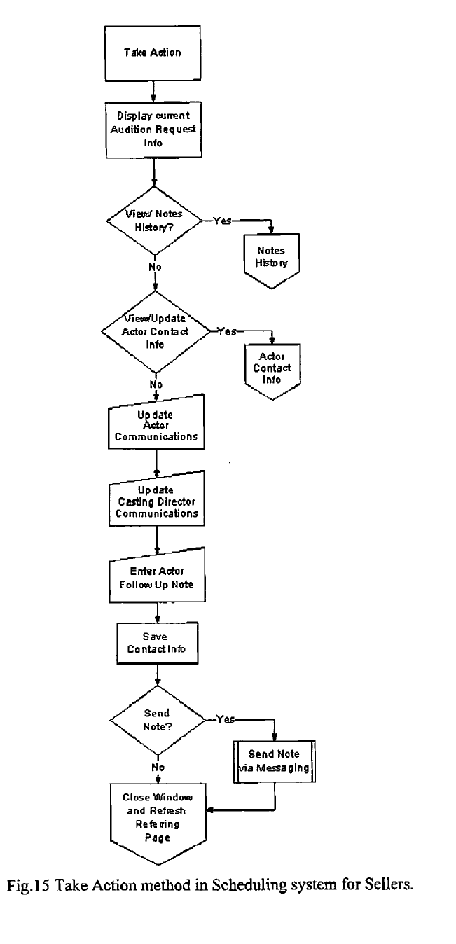

With reference to FIG. 16, which details the Notes History method in Scheduling system for Sellers, this page is accessed from various pages in the scheduling Invention. It is provided with a unique audition request. It then provides the Seller with information in three sections from scheduling and also integrated information from the Casting Workbook, for the unique audition request, as follows;
1. It displays the integrated project title and the scheduling audition date.
2. It displays a page title with the name of the related Talent from the integrated Casting Workbook Talent database.
3. It displays all the dates, sender name, recipient names, read status, subject and note content for every note in the integrated Casting Workbook Messaging system, in reverse date order.
4. When the Seller is finished viewing or printing this information, the Seller can press the “Close Window” button to close the page.

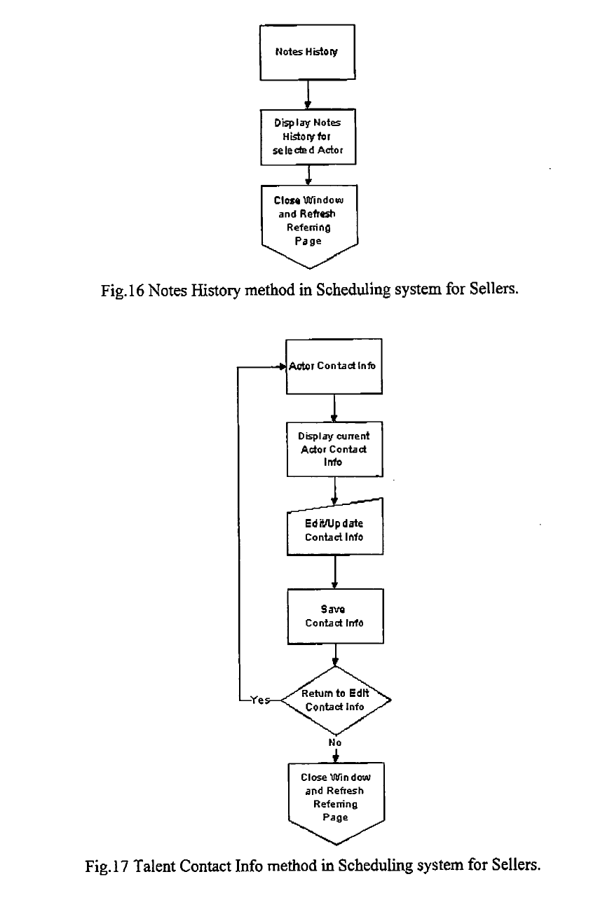

With reference to FIG. 17 which details the Talent Contact Info method in Scheduling system for Sellers, this page is accessed from various pages in the scheduling Invention. It is provided with a unique audition request. It then provides the Seller with information in two sections from integrated information from the Casting Workbook, for the Talent related to the unique audition request, as follows;
1. Current Address. It lists the current address information for the Talent in editable form fields. The Seller may choose to update this information.
2. Contact Information. It lists all the current contact methods for the Talent in editable form fields, indicating which contact method is preferred by the Talent. The Seller may choose to update this information or enter a new contact method in the form fields provided for that purpose.
3. After updating the address and contact information for the Talent the Seller may click the Save form button which will save the updated information in the integrated Casting Workbook Talent database and close the page.
4. The Seller may also click the “Save and Continue Editing” form button which will save the updated information in the integrated Casting Workbook Talent database and refresh the Talent Contact info page to allow the Seller to continue editing this information.

With reference to FIG. 18 which details the Add Talent to Sellers Scheduling system, this page is accessed from various pages in the scheduling Invention. It is provided with a Seller id and project id from the integrated Casting Workbook system, It functions as follows:
1. A new web page is provided to the Seller which lists all of the Talent from the Seller's integrated Casting Workbook roster. Each Talent name has an associated checkbox. The Seller may select the checkboxes of any of the Talent listed, and then press the “Continue” form button to advance to the next step.
2. The Seller is then presented with a table listing each of the selected Talent, along with form elements to enter an Audition Date, Time, Role and Location for each Talent. There is also a check box for each Talent to indicate to confirm this audition with the Buyer associated with the project.
3. After entering the necessary information, the Seller clicks the “Add Talent” button and the Invention processes each Talent as follows,
   a. The Invention checks for the existence of an Seller editable schedule matching the Audition Date and Role for the Talent.
   b. If such schedule exists, then the Talent, and the information entered, is added to that schedule.
   c. If no such schedule exists, then the Invention creates a new Seller-editable schedule and adds the Talent and entered audition information to the schedule.
   d. Then Add Talent web page is then closed and the referring web page is refreshed.

With reference to FIG. 19 which details the Talent Cover Pages integration to Sellers Scheduling system, this page is accessed from various pages in the scheduling Invention. It is provided with a Seller id and project id from the integrated Casting Workbook system. It functions as follows:
1. A new web page is created displaying a Cover Sheet list for the project, along with integrated project information from the Casting Workbook.
2. A list of the names of the roles in the integrated project along with cover sheet options for each role. The Cover Sheet options are:
   a. Create. If a unique Cover Sheet associated with the current Seller does not exist for a role, then a Create Link is presented. When clicked, the Invention creates a Cover Sheet for the role and Seller, and presents the Seller with the Edit Cover Sheet page, with the new Cover Sheet pre-loaded. See item c below for Functionality of the Edit page.
   b. View If a unique Cover Sheet associated with the current Seller exists for a role then a View link is presented. When clicked the Invention displays the contents of the Cover Sheet to the Seller containing integrated project and role information from the Casting Workbook database in a layout designed for printing.
   c. Edit. If a unique Cover Sheet associated with the current Seller exists for a role then an Edit link is presented. When clicked the Invention displays the contents of the Cover Sheet to the Seller containing integrated project and role information from the Casting Workbook database including six editable fields which are,
      i) Header. This is a title for the page when viewed by a Talent.
      ii) Number of pages. Indicates to a Talent how many pages of information are included in the Message.
      ii) Storyline. This is pre-loaded with the integrated storyline originally entered by the Buyer. The Seller may modify or replace this storyline for presentation to the Talent.
      iv) Buyer Comments. This is pre-loaded with the integrated comments originally entered by the Buyer. The Seller may modify or replace these comments for presentation to the Talent.
      v) Character Description. This is pre-loaded with the integrated character description originally entered by the Buyer. The Seller may modify or replace this character description for presentation to the Talent.
      vi) Seller Notes. The Seller may enter any additional notes or instructions for the Talent.
   When complete, the Seller has options to save the Cover Sheet and go to the Cover Sheet View or to save the Cover Sheet and return to the Cover Sheet List.
   d. Delete. If a unique Cover Sheet associated with the current Seller exists for a role then a Delete link is presented. When clicked the Invention deletes the Cover Sheet and refreshes the Cover Sheet List Page.
3. When finished using the Cover Sheet List, the Seller can click a “Close Window” button and the Cover Page List window will be closed and the referring page will be refreshed.

With reference to FIG. 20 that shows an overall view of the marketing module of the invention, referred to as “Now Appearing”. A web site 12 is referenced as the Presentation Layer or graphic interface of the marketing modules (“Now Appearing”). This handles the visual presentation of the workflow to create, manage and search for upcoming appearances. The same presentation layer or a different one can be used by the public to search and view appearances. The web service 14 contains methods and functions that allow the Presentation Layer 12 to retrieve or add information to the database 16, plus the business logic, and contains all core functionality to create, manage, search and view appearances. The database is any commercially available relational database. This contains the project, venue, and actor information of the upcoming appearances.

FIG. 21 illustrates the workflow for the marketing module of the invention.

1) Appearance Management Feature

This feature allows Sellers to add appearance information and edit existing appearance information.

a. Add an Appearance

All Sellers who have an account are able to add appearance information. Appearance Information will include the name of the Role, and the role type, for example, Lady Macbeth, Principle Role. Each appearance is tied to a production or project, such as “Shakespeare's Macbeth”. Each Production is assigned a venue type. A venue type defines the type of information the application displays when adding or managing information. Examples of a venue type are: Film; Theatre; Television (TV); or Print ad. If the venue type is Theatre then information about the address for the venue will be asked and displayed. If the venue type is TV then there will be no information about an address but a network channel within each country. Each appearance is related to a location search zone. A search zone can be a country, state or city. The search zone is not related to a particular city but a grouping of cities, for example—Los Angeles would include areas around Los Angeles: Hollywood, Burbank, Santa Monica, etc. Search zones are used for searching. The option to search in a specific city is available, but users may not be that specific, so the invention allows them to search by zone to pick up appearances they would not have seen if they were searching by city. Search zones allows for larger search results.

When an appearance is being added, the invention does a search looking for an appearance with the same information. If it finds one, then the new appearance is added to the existing, with the new role and Talent information. Talent and Seller can search and from any appearance add themselves, or they can follow a formal process of adding the production, venue, and search zones. Venues and Production can add their performances and Actor information the same way a Seller does.

b. Edit an Appearance

Only the creator or owner of the appearance is able to edit the appearance's production, venue and date/time information (if it has not past). Each appearance is defined by the date and venue, not the actual role. So if the appearance is with a traveling road company, a person can enter in the production once and enter in as many location venues and appearance dates they wish but once an appearance date is past then the appearance is no longer editable, however the data and location of future appearances will be. In other words no past appearance can be edited.

The first Seller to add an appearance venue and date becomes the owner of that appearance and only they can edit the information. If a user added Talent information to an existing production they will only be able to edit the Talent's information, however the owner can also edit the production information, venue and date/time.

2) Search for Appearances

Buyers, Sellers, Talent and the Anonymous Public (“users”) can search for any appearance in the system. The Public can only search for future appearances, everyone else can search in the past for historical information. The default search presents “today's” appearance information for a default search zone. If the invention detects a cookie, which was given to the user from a past search, it will use the information found in the cookie for the default search zone. The default search zone is global or worldwide releases such as Film or TV. Users are able to search and filter results based on venue types, venues, locations, role titles, role types, date, production and talent. For example, a user can search for only Theatre venues in Toronto. The user can search by production. The user can search by Talent. From the search results, the user clicks on the date of the appearance to see more detailed information. From the detail page the user clicks on the venue to see a list of all appearances at that venue with date and times. The user clicks on the production and see further details. Users can also save searches (except Public). From any search page, they can pick from a list of saved search parameters, or they can create a new search and from the search result page click to save the search parameters.

3) Tickets Requests for Will Call

Sellers often give away free tickets to Buyers to entice them to see the performance. If tickets are available, an option was checked during the add workflow with information on how to request the tickets. This information is presented on the appearance detail page, except Public users do not see this option. The user (except Public) clicks on the request link and an email is generated to the Seller with the user's information asking for information. The Seller contacts the Buyer giving them specific information on where the tickets will be available.

5) Watch List

Users (except Public) can watch for a specific appearance. The watch can be of an Actor, Project or even Venue. The watch list also acts like a quick find list, so the user can view this list to see upcoming performances, plus the user can have the invention email them with reminders for the upcoming performances. (See Notify Me).

5) Notify Me

Users can request to be notified when a new appearance is added for a specific Project, Actor or Venue, or to be reminded of the upcoming event. The invention will email the user with information about the performance and a link to the details. Users can specify the frequency of these notifications to be immediate (as it is added or changed), daily, weekly or monthly. Only one email is generated for that frequency so if they are watching three Actors, then one email for all three Actors are generated.

6) Manage Users/Self Administration Pages

Users (except Public) are able to manage constant information such as the notification email, preferences and default search zone.

7) Admin Tools

The invention allows Administrators of the application or web site a set of tools to manage all appearances. The tools provide ways to prevent abuse of the system, assist users when they are unable to perform the workflow, and to watch the data to make sure it is clean and correct as possible.

The invention therefore provides a method of utilizing the Internet to create, manage and report audition schedules; store and distribute supporting documents for the audition; upload the session clips to a secure web service; provide the means to distribute videos securely; and provide the means for the Buyers and Sellers to market the project and actors. Buyers can electronically create, manage and transmit Breakdowns to Sellers, who submit Actors for the roles of the Breakdown electronically. Sellers manage and track their electronic submissions. After receiving the submissions, the Buyer uses the invention to manage the received submissions. The Buyer assigns actors to a pre-assigned A, B or C list or they can sort the submissions by role and then to an A, B or C list. The invention also allows a Buyer to work independently. They do not have to transmit the Breakdown to Seller, and can add actors from a pre-existing database of talent. After the sorting process, the invention allows the Buyer to create and manage audition schedules by using the sort lists, or adding actors from the database of talent. The Buyer can manually assign the order and times the actors will audition, or they can allow the invention to automatically assign the times, or a combination of both. For example, the Buyer assigns audition times to certain actors in the schedule, the Buyer can then have the invention fill in the audition times for the remaining actors. The invention will electronically transmit audition times and supporting information to Seller in a fraction of the time required using the traditional methods. The invention creates and sends emails to the Seller notifying them of the audition for their actor(s). The email sent by the invention provides the Seller the option to reply to the audition request through their email or by logging on to a secure website. The Seller does not need to be a member of the subscription web site that uses the invention. The invention works with Sellers that are members and are non-members of the subscription website, provided the Seller has a valid email account. The Invention provides the responses from member and non-member Sellers in one integrated system to make managing the auditions easier for Buyers.

The invention also integrates with an internal messaging system within the subscription web site, so when Sellers are logged into the system they have another way of being notified of a pending audition. The invention allows Sellers to send supporting documents, scripts and script parts, to their actors electronically, plus they can track how many times the documents were sent. They also have the ability to send the whole breakdown or just the relevant parts the Actor needs to prepare for the audition. The invention has an extensive reporting module. The invention tells the Buyer when the Sellers have received and read the audition notification, plus the Seller is notified when the Actor has received and read the notification and supporting documents. The invention allows for notes to be passed between Buyers to Sellers to Actors and back again. This is useful when the Seller must regret the audition time, as it allows for the Buyer and Seller to negotiate a new time. It allows the Buyer to provide information needed for the audition that is not provided in the breakdown or supporting documents, for example a style of clothing to wear for the audition. Since all communications are tracked and reported, it automatically keep track of changing information, such as the time of audition or last-minute instructional notes. The invention provides a way for a Buyer to use the invention when the Seller does not use a computer and prefers to use the traditional system. The Buyer can mark the audition time for that Seller as confirmed or regretted as well as keep notes on the Actor and whether supporting material was sent. If the Buyer does not use a computer and prefers to use traditional methods, the Seller can create schedules and use the tools available to send notifications and supporting documents to their Actors.

After the audition session has finished, or during the session, the Buyer or one of their assistants, can mark the order that the actors arrived and read, any notes about the audition and the file name of the audition video. If the files are already on the subscription's FTP server, the Buyer can then upload the audition videos immediately, save the information, or schedule the upload for later time. If the videos aren't currently uploaded to the FTP Server, the Buyer enters the information and schedules the upload to happen when all videos are currently present on the servers. The invention will take the audition schedule using information from the schedule, transfer the videos into the subscription system and generate reports. One report that is generated is a Tape Log Report that details the Actors that were video taped, the order that they came in to audition, the role, notes about their audition and if the Buyer has selected them for the role or for a call back—a second audition. After the role is cast, the Seller will use the marketing methods of the invention (“Now Appearing”) to announce the Actor's upcoming performance.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of using the Internet to permit a Buyer to schedule and manage auditions of Talent for a project with Sellers representing said Talent, said Buyer having a computer with a web browser and said Sellers each having a computer with electronic mail capability, the method comprising:
i) providing a web site accessible over the Internet to said Buyer and communicating with a database;
ii) said Buyer accessing said web site and selecting a project for audition scheduling;
iii) said Buyer building a preliminary schedule by a) setting the audition start time and date, the number of Talent to be auditioned, and the length of time for each audition; b) selecting and ranking Talent for a particular role; and c) assigning a time for each Talent audition;
iv) said Buyer sending said preliminary schedule to Sellers representing said Talent by electronic mail as an audition request; and
v) said Buyer updating said schedule according to the responses received from said Sellers.

2. The method of claim 1 wherein times for each Talent are automatically assigned to Talent based on said ranking.

3. The method of claim 1 wherein times for each Talent are also manually assigned.

4. The method of claim 1 wherein said preliminary schedule is displayed to said Buyer without photographs of the scheduled Talent.

5. The method of claim 2 wherein schedules on additional dates are provided if more Talent are on an audition schedule than can be accommodated within the time parameters of the schedule.

6. The method of claim 1 wherein supporting information and notes are attached to said audition requests.

7. The method of claim 1 wherein a report to said Buyer is provided listing Sellers who were sent the audition request.

8. The method of claim 1 wherein a Buyer updates said schedule by recording confirmations and regrets from Sellers.

9. The method of claim 1 wherein audition times are re-assigned after the preliminary schedule request has been sent and any affected Seller is notified electronically of the change.

10. The method of claim 1 wherein said Buyer selects one or more Talent from a schedule for callbacks.

11. The method of claim 10 wherein said Buyer creates a new schedule with only those Talent selected for callbacks.

12. The method of claim 1 wherein Sellers confirm or regret audition requests online, through said website or by email.

13. The method of claim 1 wherein said Buyer uploads digitally taped auditions to a server based on the audition schedule.

14. The method of claim 1 wherein Talent is selected from said database.

15. The method of claim 1 wherein said Buyer specifies the audition order of Talent in schedules which contain more than one role, by specifying the order of roles to audition or to audition one or more Talent from each role in a group.

16. The method of claim 1 wherein said Buyer updates said schedule by adding Talent, switching Talent from one role to another, removing Talent or assigning Talent to specific roles in said schedule

17. The method of claim 1 wherein said step of forming and sending said email to said Sellers is carried out by a Web Service.

18. A computer program product for using the Internet to permit a Buyer to schedule and manage auditions of Talent for a project with Sellers representing said Talent, said Buyer having a computer with a web browser and said Sellers each having a computer with electronic mail capability, and wherein a web site accessible over the Internet to said Buyer and communicating with a database is provided, comprising:
a computer usable medium having computer readable program code means embodied in said medium for:
i) permitting said Buyer to accessing said web site and selecting a project for audition scheduling;
iii) permitting said Buyer to build a preliminary schedule by a) setting the audition start time and date, the number of Talent to be auditioned, and the length of time for each audition; b) selecting and ranking Talent for a particular role; and c) assigning a time for each Talent audition;
iv) permitting said Buyer to send said preliminary schedule to Sellers representing said Talent by electronic mail as an audition request; and
v) permitting said Buyer to update said schedule according to the responses received from said Sellers.

19. The computer program product of claim 18 wherein times for each Talent are automatically assigned to Talent based on said ranking.
